(19) United States
(12) Patent Application Publication
(10) Pub. No.: US 2017/0202182 A1
(43) Pub. Date: Jul. 20, 2017

(54) TREAT DISPENSERS AND METHODS OF USE THEREOF

(71) Applicant: Big Heart Pet Brands, San Francisco, CA (US)

(72) Inventors: Lindsay R. Bolter, Fairfax, CA (US); Zachary H. Burchman, Chicago, IL (US); Marissa S. Gomes, Walnut Creek, CA (US); James E. McCollum, San Mateo, CA (US); Thomas M. McKeon, Wheaton, IL (US); Gabrielle B. Pavelko, San Francisco, CA (US); Justin B. Peart, Clarendon Hills, IL (US); Jonathan R. Zayat, Iowa City, IA (US)

(21) Appl. No.: 15/001,837

(22) Filed: Jan. 20, 2016

Related U.S. Application Data
(63) Continuation of application No. 29/551,916, filed on Jan. 19, 2016.
Application No. 29/551,916 is a continuation of application No. 29/551,918, filed on Jan. 19, 2016.
(60) Provisional application No. 62/280,363, filed on Jan. 19, 2016.

(51) Int. Cl. A01K 15/02; A01K 5/02

(52) U.S. Cl. CPC A01K 15/025; A01K 5/02

(57) ABSTRACT

The invention provides a dispenser configured to house one or more freely moveable treats in a hollow interior cavity and to randomly release treats through a limited number of dispensing holes only if a treat is in a limited orientation relative to a dispensing hole. The dispenser is made of a flexible, resilient material into a shape that promotes an irregular bounce when the dispenser contacts a generally flat surface. The dispenser can be used to promote prolonged engagement by challenging a pet to cognitively manipulate the dispenser so that treats inside the dispenser are randomly released.

### CROSS-REFERENCE TO RELATED APPLICATIONS

This application claims the priority and benefit of U.S. Provisional Patent Application No. 62/280,363, titled “Treat Dispensers and Methods of Use Thereof,” filed on Jan. 19, 2016; U.S. Design Application No. 29/551,916, titled “Treat Dispenser,” filed on Jan. 19, 2016; and U.S. Design Application No. 29/551,918, titled “Treat Dispenser,” filed on Jan. 19, 2016; the entireties of which are incorporated herein by reference herein in their entirety and for all purposes.

### FIELD OF THE INVENTION

The present invention generally relates to treat dispensers and, more specifically, to pet treat dispensers that are elastic, that have distinct hollow core structures that cause them to interact unpredictably when coming into contact with a generally flat surface, and that permit random release of treats through dispensing openings, all of which encourage and prolong a pet's interaction with the dispensers.

### BACKGROUND OF THE INVENTION

Pet owners seek to foster the well-being of their pets. One way an owner cares for his/her pet is to provide toys that cognitively challenge and stimulate sensory interaction from the pet, as well as promote physical exercise. This supports and improves a pet's health and quality of life. To be effective, a toy should stimulate prolonged engagement by the pet. Engagement is used generally to refer to a pet's physical interaction with a toy to satisfy an urge, such as the urge to chew the toy, to play with the toy, and/or to obtain a reward, such as a treat, from the toy. Engagement can occur during a pet's solitary play with a toy, or a pet's interactive play with the toy and a person or with the toy and other pets.

Prolonged engagement with a toy further enhances the benefits of a toy's ability to promote cognitive challenge(s), sensory stimulation, and physical exercise. A pet's engagement with a toy can be prolonged by providing treats within the toy that can be visually and/or olfactorily sensed by the pet, but not immediately accessible to the pet, which must physically manipulate the toy to release the treat for its reward.

Many different interactive pet toys have been designed to stimulate pets. Chew toys, for example, provide an outlet for animals such as dogs to satisfy the instinctual urge to masticate, which keeps jaws strong and teeth clean, as well as to combat boredom and to relieve anxiety or frustration. A number of interactive pet toys have been developed to increase the length of time that a pet interacts with a toy. Certain chew toys include integrated treats that pique a pet's interest because of the reward of an edible treat. Other interactive toys include throw toys that stimulate pets to engage in physical exercise, which keeps a pet active and helps to release pent up energy. By increasing the intensity and length of time a pet is occupied, the pet will be less prone to engage in negative behaviors such as chewing on furniture. Interactive pet toys keep pets physically active and mentally engaged.

A consumer typically enjoys the response received from providing his/her pet with an interactive toy. A pet's prolonged engagement with an interactive toy—either on its own or during interaction with its owner—means that the pet is being stimulated physically and mentally to maintain the pet's overall health and well-being. As a result, consumers are now seeking pet treat dispensers that provide cognitive challenges and lengthen engagement time with a pet at play.

The subject matter disclosed herein relates to pet treat dispensers that improve upon or overcome one or more of the shortcomings of existing pet toys and dispensers.

Some advantages of the invention include the following: (1) a treat dispenser that internally houses one or more freely moveable treats, e.g., rectangular-shaped, bone-shaped, or other 3-dimensional-shaped treats, in a hollow interior cavity and that randomly releases treats through dispensing holes or openings if and only if a treat is in a limited orientation relative to a dispensing hole, whereby the treat can exit the dispensing hole as the dispenser is tossed, bounced, rolled, or manipulated by a pet; (2) a treat dispenser that promotes prolonged engagement by challenging a pet to cognitively manipulate the dispenser so that treats inside the dispenser are randomly released; (3) a treat dispenser that has different shaped and/or sized dispensing holes, thereby presenting various levels of difficulty to randomly release treats therefrom; (4) a hollow treat dispenser made from an elastic material in a shape that interacts unpredictably with a generally flat surface, such as, for example, an irregular or random bounce or roll, which can consequently stimulate physical exercise as the pet works to control the dispenser; (5) a treat dispenser that a pet can chew without injuring its teeth or gums, while contemporaneously protecting the treats inside the dispenser from being chewed or crushed by the pet; (6) a treat dispenser made of a material that floats; (7) a treat dispenser made with a material that is durable against wear and tear of use; (8) a treat dispenser made of a material that can be transparent, translucent, or opaque; and (9) a treat dispenser with the aforementioned characteristics that is easy to manufacture using existing molding technologies.

### BRIEF DESCRIPTION OF THE FIGURES

The description discloses inventions that are illustrated with reference to the accompanying figures to advise one of ordinary skill in the art of the characteristics and benefits of the invention. In the various views of the figures, like reference characters designate like or similar parts, whereby:

FIG. 1 shows a front isometric view of an embodiment of a treat dispenser of the present invention.

FIG. 2 shows a front elevation view of the treat dispenser shown in FIG. 1.

FIG. 3 shows a rear elevation view of the treat dispenser shown in FIG. 1.

FIG. 4 shows a top plan view of the treat dispenser shown in FIG. 1.

FIG. 5 shows a bottom plan view of the treat dispenser shown in FIG. 1.

FIG. 6 shows a side elevation view of the treat dispenser shown in FIG. 1.

FIG. 7 shows another side elevation view of the treat dispenser shown in FIG. 1.

FIG. 8 shows a front isometric view of the treat dispenser shown in FIG. 1 while particularly emphasizing the continuous segment of the treat dispenser.

FIG. 9 shows a top plan view of the dispenser shown in FIG. 8.

FIG. 10 shows a bottom plan view of the dispenser shown in FIG. 8.

FIG. 11 shows a front elevation view of the dispenser shown in FIG. 8.

FIG. 12 shows a side elevation view of the dispenser shown in FIG. 8.

FIG. 13 shows a cutaway view of an intersection of an end cap, segments, and arms of the treat dispenser shown in FIG. 1.

FIG. 14 shows a cross sectional view of a segment shown in FIG. 2.

FIGS. 15a, 15b show a top plan view and a cutaway view showing radii of curvature of the inner surface and the outer surface of the treat dispenser.

FIG. 16 shows a segment of the treat dispenser of FIG. 1 in contact with a generally flat surface.

FIG. 17 shows a front isometric view of another embodiment of a treat dispenser of the present invention.

FIG. 18 shows a front elevation view of the treat dispenser shown in FIG. 17.

FIG. 19 shows a rear elevation view of the treat dispenser shown in FIG. 17.

FIG. 20 shows a top plan view of the treat dispenser shown in FIG. 17.

FIG. 21 shows a bottom plan view of the treat dispenser shown in FIG. 17.

FIG. 22 shows a side elevation view of the treat dispenser shown in FIG. 17.

FIG. 23 shows another side elevation view of the treat dispenser shown in FIG. 17.

FIGS. 24a, 24b, 24c show top plan, isometric, and exploded views of the treat dispenser shown in FIG. 17 manufactured by two-piece construction.

FIGS. 25a, 25b, 25c show top plan, bottom plan, and isometric views of the treat dispenser shown in FIG. 17 manufactured by an alternative two-piece construction.

FIGS. 26a, 26b show front elevation and side elevation views of a pet treat.

FIG. 27 shows a front isometric view of another treat dispenser of the present invention.

FIG. 28 shows another front isometric view of the treat dispenser shown in FIG. 27.

FIG. 29 shows a front elevation view of the treat dispenser shown in FIG. 27.

FIG. 30 shows a rear elevation view of the treat dispenser shown in FIG. 27.

FIG. 31 shows a top plan view of the treat dispenser shown in FIG. 27.

FIG. 32 shows a bottom plan view of the treat dispenser shown in FIG. 27.

FIG. 33 shows a side elevation view of the treat dispenser shown in FIG. 27.

FIG. 34 shows another side elevation view of the treat dispenser shown in FIG. 27.

FIG. 35 shows an exploded view of the treat dispenser shown in FIG. 27.

FIGS. 36a, 36b show sectional views as depicted in FIG. 33 of the treat dispenser shown in FIG. 37.

FIG. 37 shows the treat dispenser of FIG. 27 rolling on a generally flat surface.

### DESCRIPTION OF THE INVENTION

This description of the invention is intended to be read in connection with the accompanying figures depicting embodiments of the invention. In the description of the invention, any reference to direction or orientation is intended for convenience of the description and is not intended in any way to limit the scope of the present invention. Relative terms such as “lower,” “upper,” “horizontal,” “vertical,” “above,” “below,” “up,” “down,” “top,” “bottom,” “front,” “rear,” and “side,” as well as derivatives thereof, should be construed to refer to the orientation as then described or as shown in the drawing under discussion. These relative terms are for the convenience of description only and do not require that the treat dispenser 100, 100′ or treat dispenser 200 be constructed or operated in a particular orientation unless explicitly indicated as such. Terms such as “attached,” “adhered,” “affixed,” and the like refer to a relationship wherein structures are secured or attached to one another, either directly or indirectly through intervening structures. The characteristics and benefits of the disclosed and/or claimed invention are illustrated by reference to the embodiments, but is not limited thereby.

In general, and unless otherwise indicated, singular elements may be in plural and vice versa with no loss of generality.

As used herein, each of the following terms has the meaning associated with it in this application.

The term “pet” is used to refer to an animal of the type for which the treat dispenser 100, 100′ and the treat dispenser 200 described herein are intended to be used. By way of example, the treat dispenser 100, 100′ and the treat dispenser 200 are intended for use by toothed pets or domesticated animals such as, but not limited to, dogs, cats, hamsters, gerbils, and other animals.

The term “treat” is used to refer to pet treats and foodstuffs that can be consumed by a pet and may take various shapes and sizes, such as, for example, uniformly sized treats including bone-shaped treats 400 (e.g., MILKBONE® biscuit) or a 3-dimensional rectangular-shaped or cube-shaped treat; irregularly sized and shaped treats; or treats of other size and shape configurations.

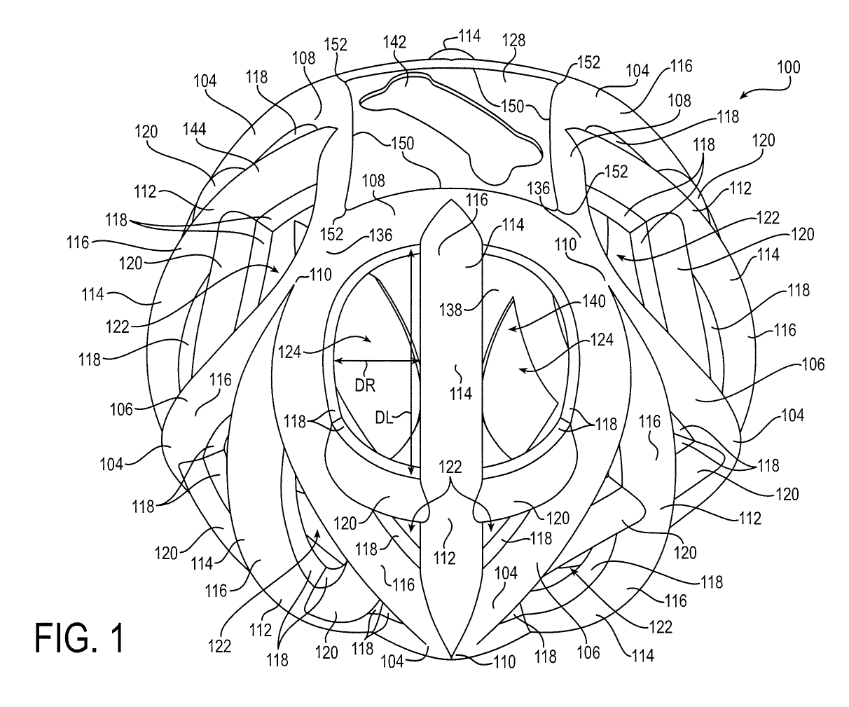

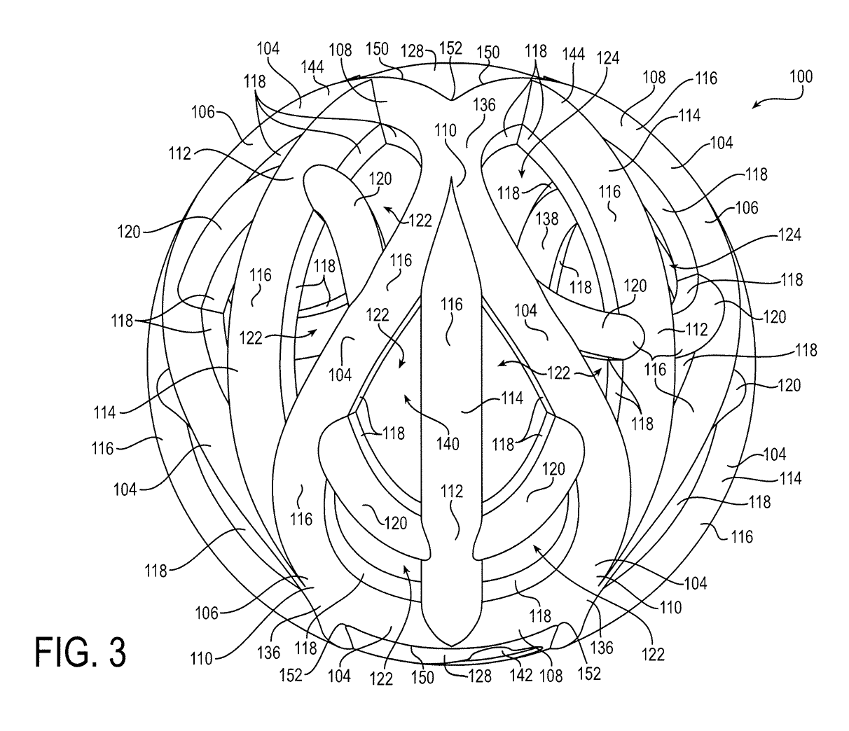

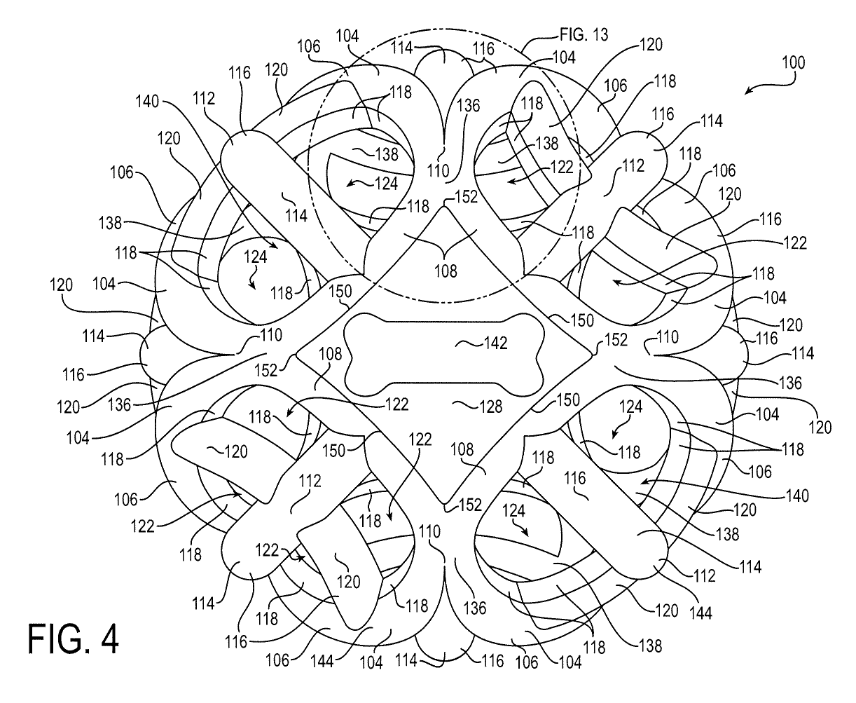

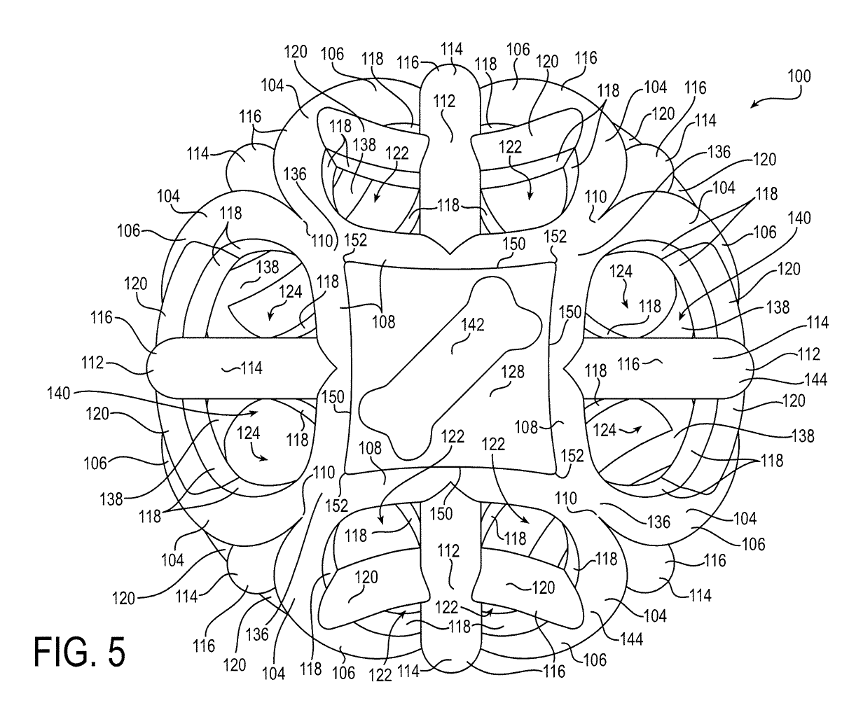

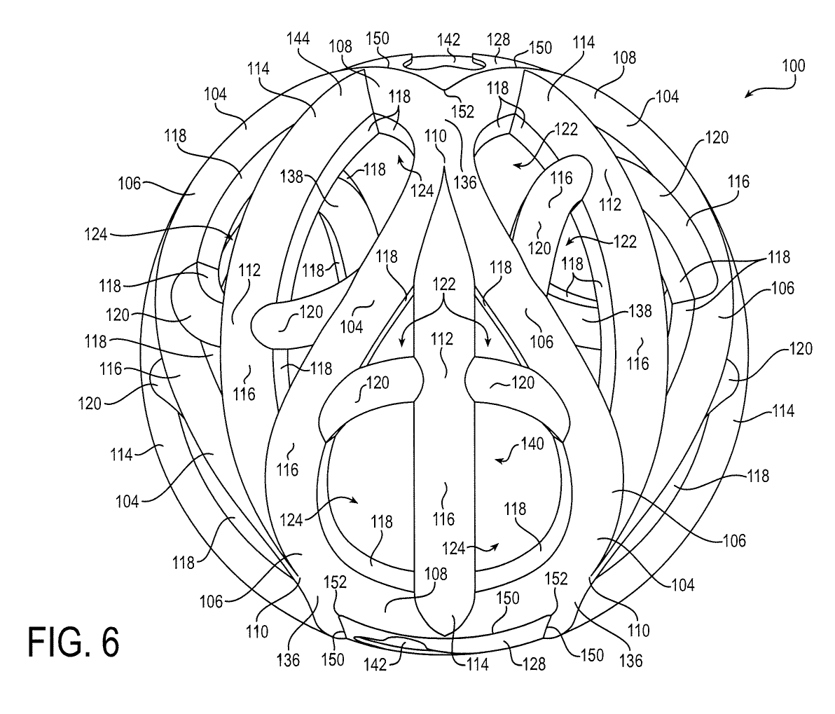

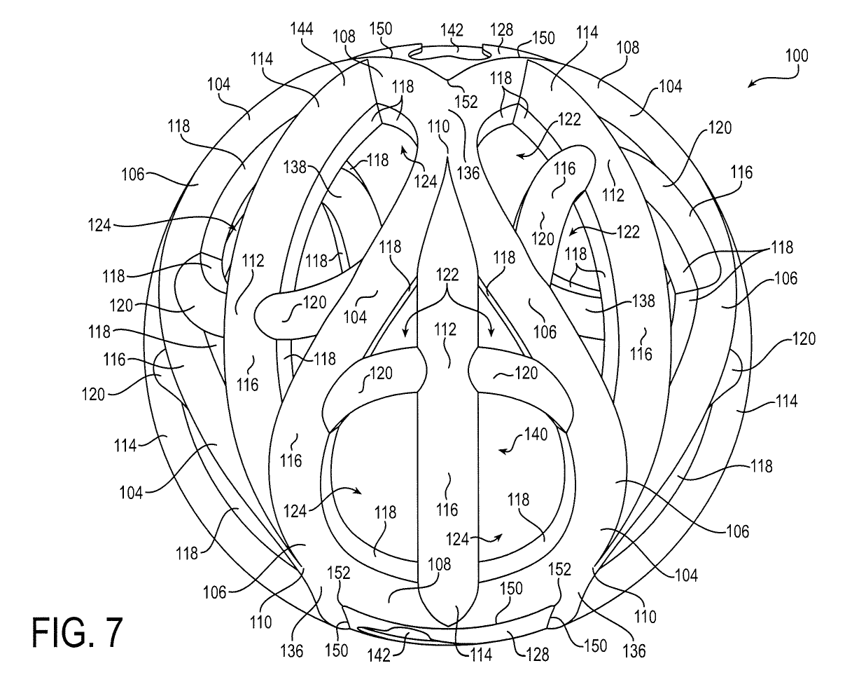

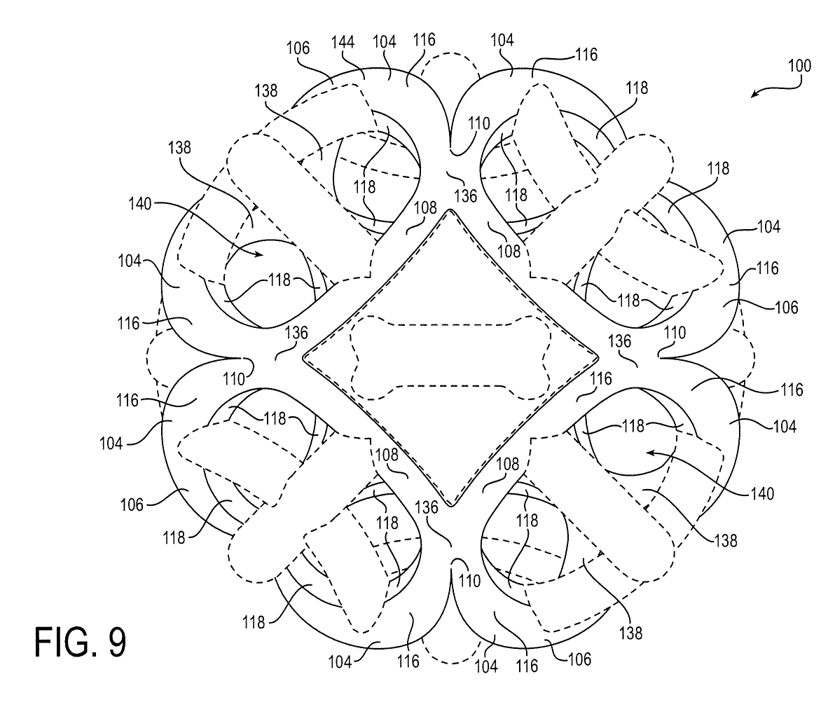

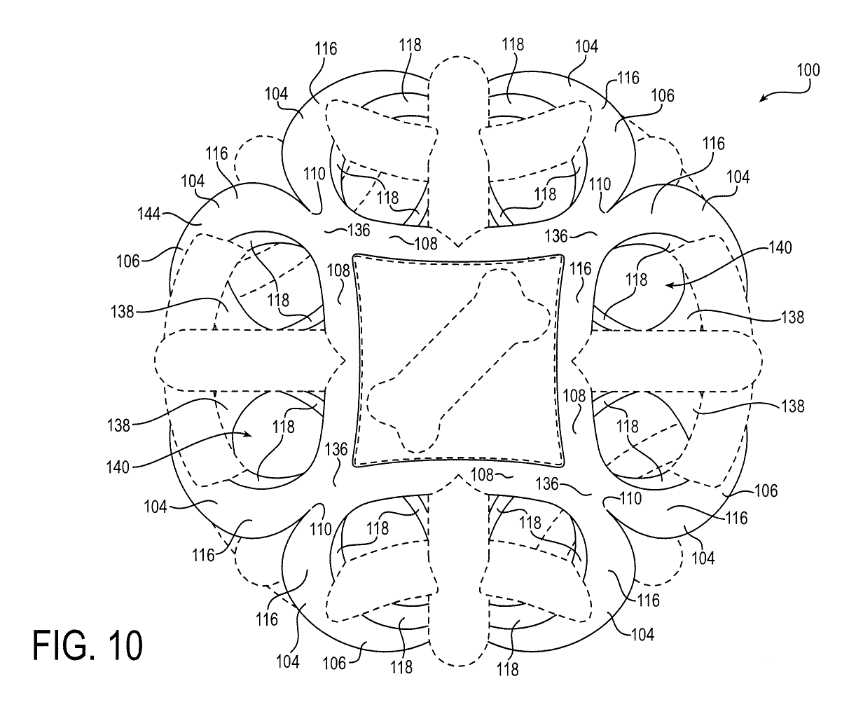

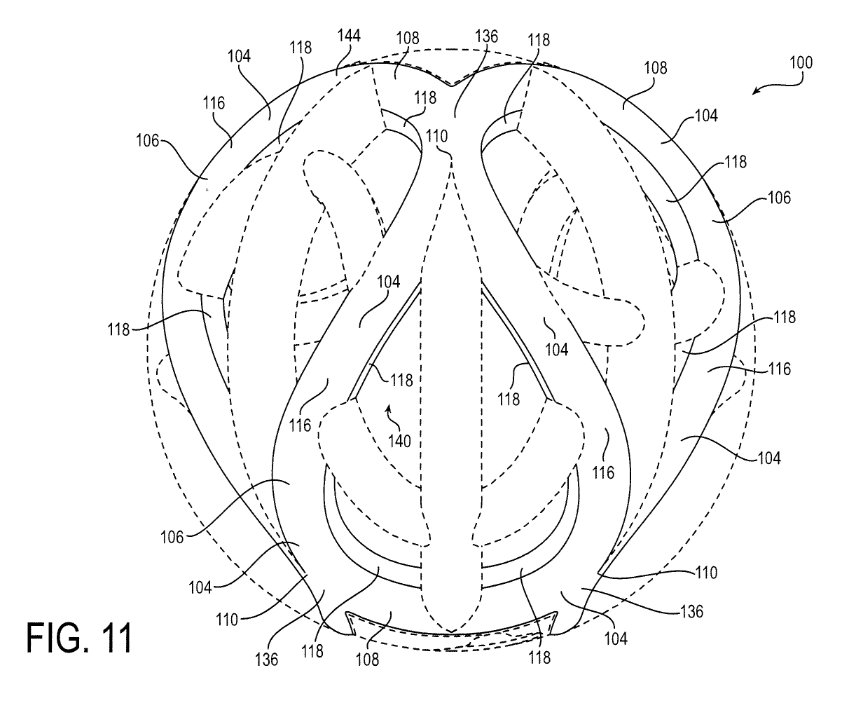

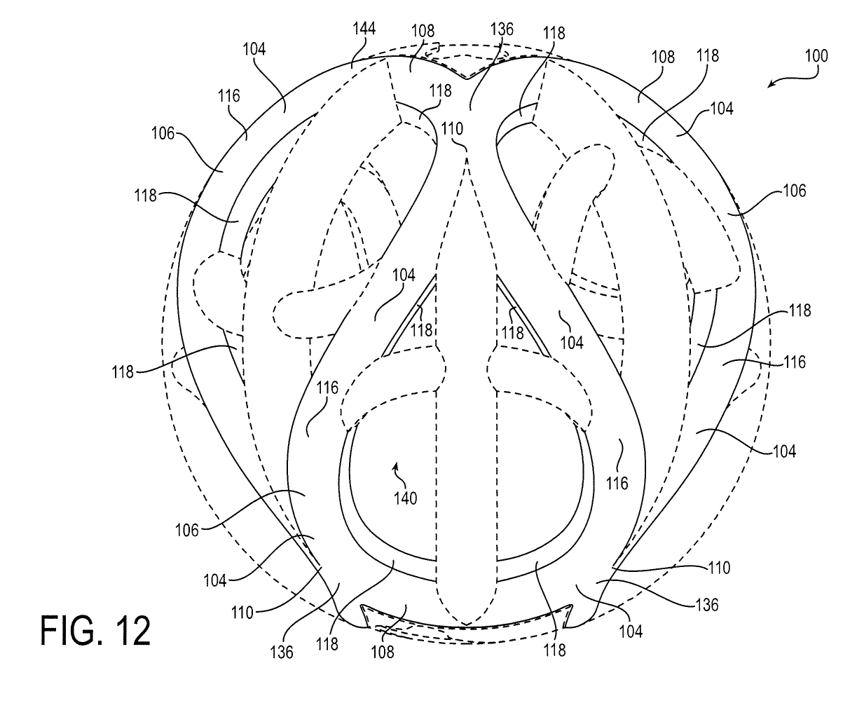

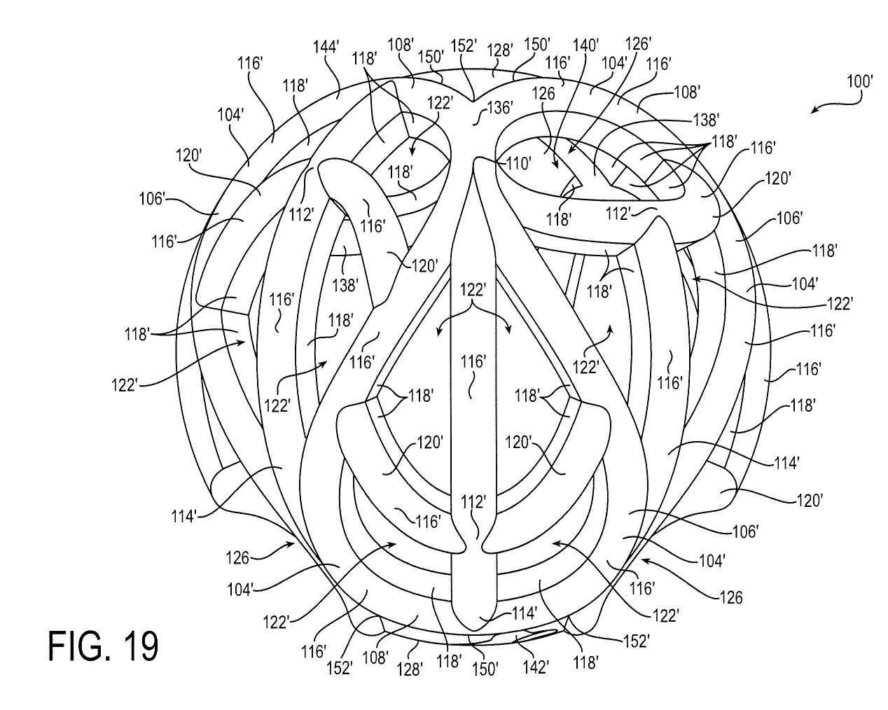

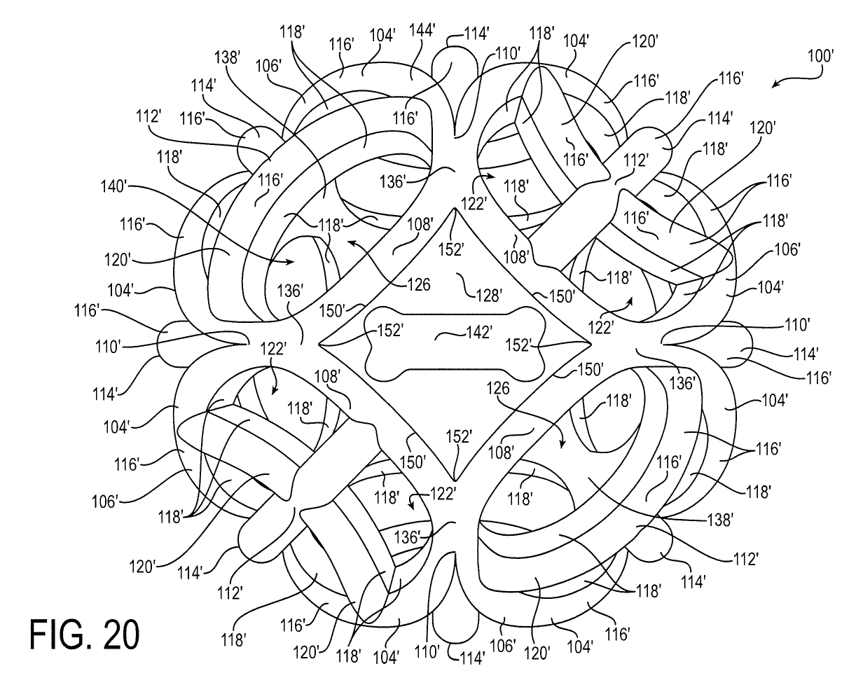

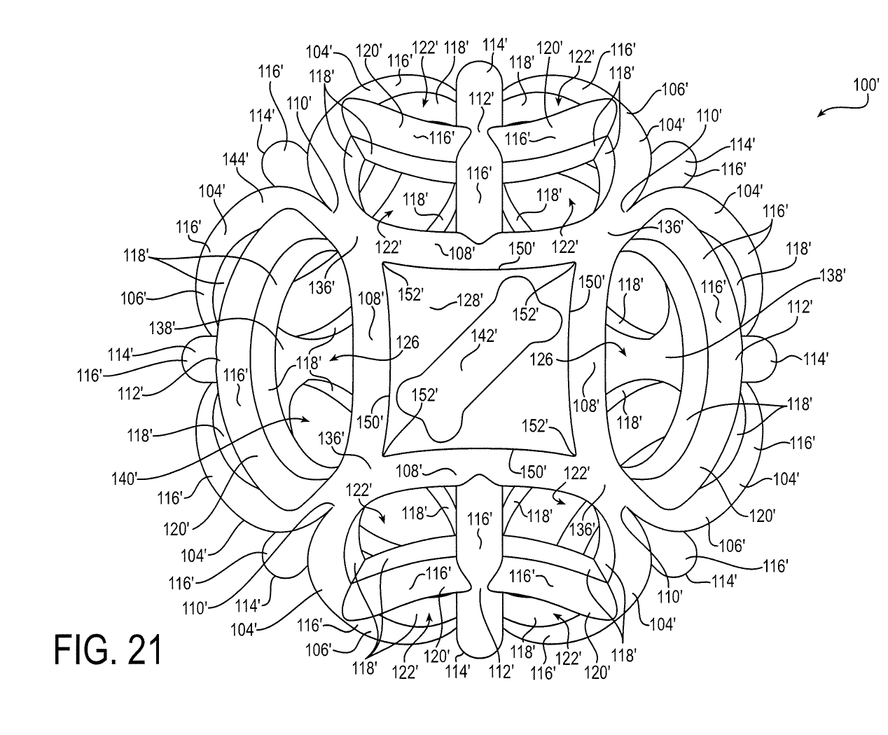

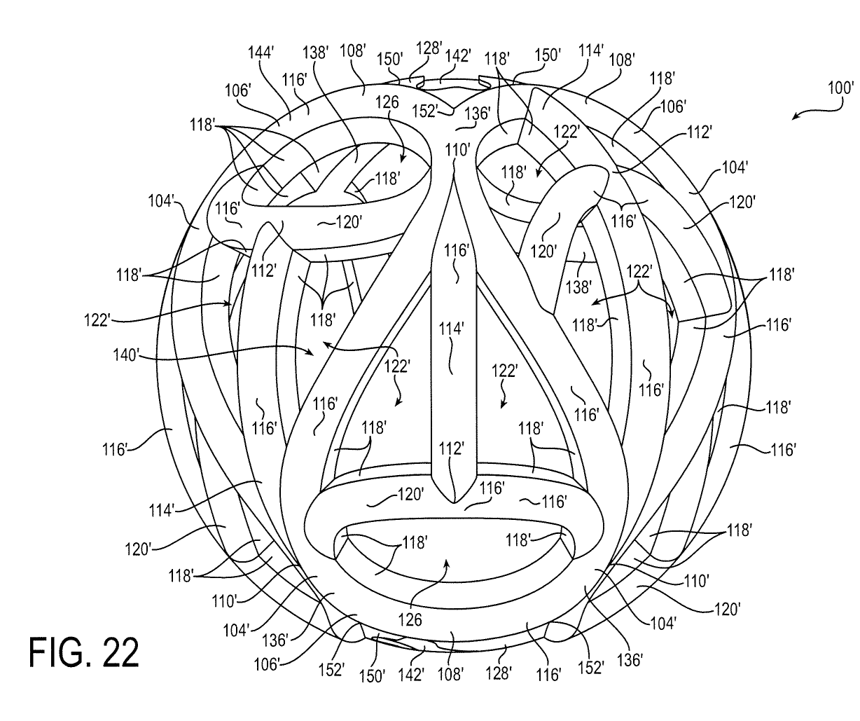

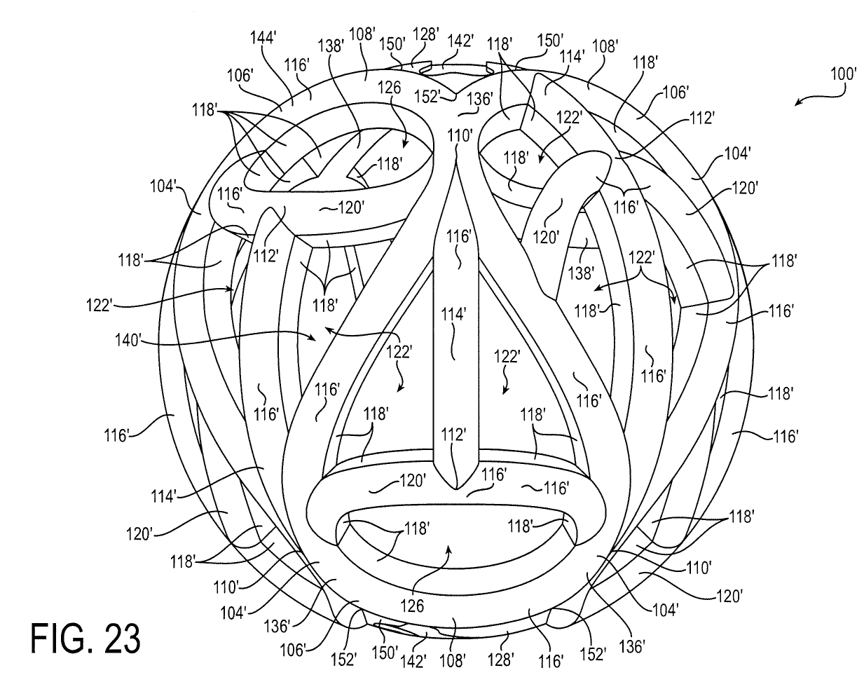

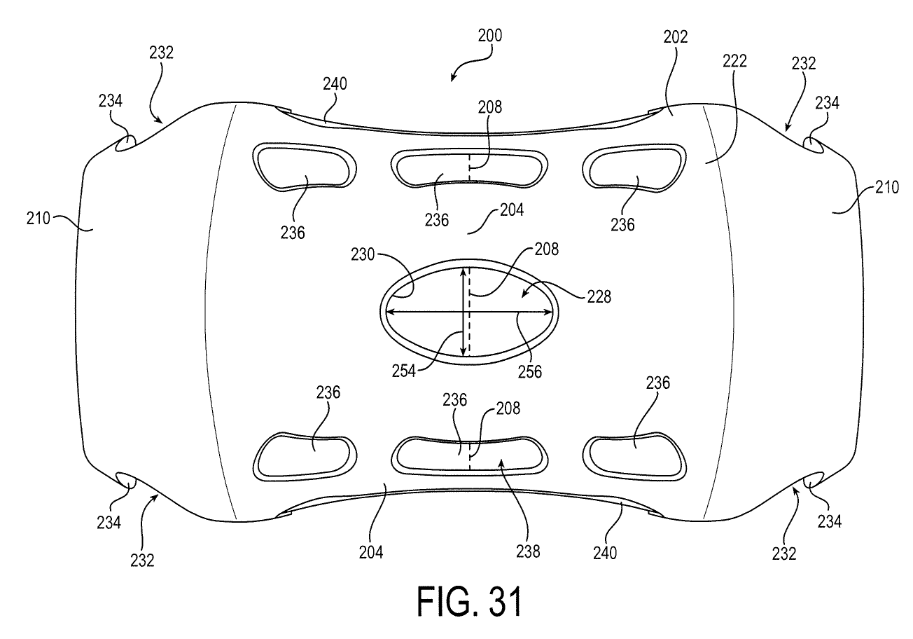

Referring generally to FIGS. 1-25c and 27-37, the present invention is directed to a treat dispenser 100, 100′, as well as a treat dispenser 200, that is useful for prolonging a pet's cognitive, sensory, and physical engagement of the dispenser 100, 100′ or dispenser 200 during use. In the broadest sense, the treat dispenser 100, 100′ and treat dispenser 200 provide a hollow body comprising a curved external surface made of an elastic material that promotes an unpredictable physical interaction embodied by an irregular or random bounce upon forcible contact with a generally flat surface such as a floor, a road, a driveway, a wall, or the like. Treat dispenser 100, 100′ and treat dispenser 200 are also useful for randomly dispensing treats that have been loaded into the internal hollow body. The treat dispenser 100, 100′ and the treat dispenser 200 are useful as toys or training aids for pets or humans.

The unpredictability of the physical interaction is caused by the unique external characteristics of the open framework of the pet treat dispenser 100, 100′, which causes the dispenser 100, 100′ to bounce randomly or irregularly after forcible contact with a generally flat surface E, as well as to roll randomly and irregularly on a generally flat surface E. The dispenser 200 also interacts unpredictably with a flat surface E due to its elliptically-shaped lobed ends 210 at opposing ends of the shaft 204 of the dispenser 200. While the dispenser 200 is configured to roll generally linearly along a flat surface E, the dispenser 200 will also randomly or irregularly roll while accelerating or decelerating due to its elliptical external shape that is configured perpendicular to its longitudinal axis Z about which the dispenser 200 can rotate. The dispenser 200 will also rebound randomly or irregularly if it comes into forcible contact with a flat surface E, which causes an unpredictable interaction with the generally flat surface E.

This unpredictable interaction posed by the invention challenges a pet to physically interact with, and even control, the random movement of the dispenser 100, 100′ or the dispenser 200 during use. In addition to stimulating physical interaction through its unpredictive interactive characteristics, the dispenser 100, 100′, 200 also cognitively challenges a pet to spatially manipulate the dispenser 100, 100′, 200 in an attempt to cause treats 400 loaded inside the dispenser 100, 100′ or the dispenser 200 to be released so that the pet can consume one or more of the treats 400.

Referring generally to FIGS. 1-25c and 27-37, the treat dispenser 100, 100′ and treat dispenser 200 promote prolonged engagement by a pet by providing treats 400 within the dispensers 100, 100′, 200 that can be visualized, smelled and/or heard by the pet, but not immediately accessed by the pet. The hollow interior cavity 140, 140′ of the pet treat dispenser 100, 100′, as well as the hollow interior cavity 238 of the pet treat dispenser 200, is configured to retain one or more freely moveable treats 400. As the treats 400 move around within the hollow interior cavity 140 of dispenser 100, 100′ during use, for example, the treats 400 will come into contact with the inner surface 138 of the dispenser 100, 100′, and will bounce around within and remain in the dispenser 100, 100′ unless the treat 400 is in one of a small amount of spatial orientations relative to the dispensing openings 124, 126 that permit passage through a dispensing opening 124, 126, while the dispenser 100, 100′ is tossed, bounced, rolled, or physically manipulated by a pet or human. More specifically, a treat 400 can be randomly released through a dispensing opening 124, 126, for example, when the longitudinal axis T of the treat 400 is spatially oriented generally perpendicular to the dispensing opening 124, 126 along a radius generally centered through the dispensing opening 124, 126 so that the treat 400 can pass from the hollow interior cavity 140 through the dispensing hole 124, 126 and out of the dispenser 100, 100′. Additionally, the random release of treats 400 from dispenser 100, 100′ can also be controlled by the spatial orientation of the width W and depth D of the treat 400 relative to the dispensing opening 100, 100′. A similar random release function related to the spatial orientation of the treat 400 relative to dispensing openings 228, 232 and loading opening 218 of the dispenser 200 occurs during use.

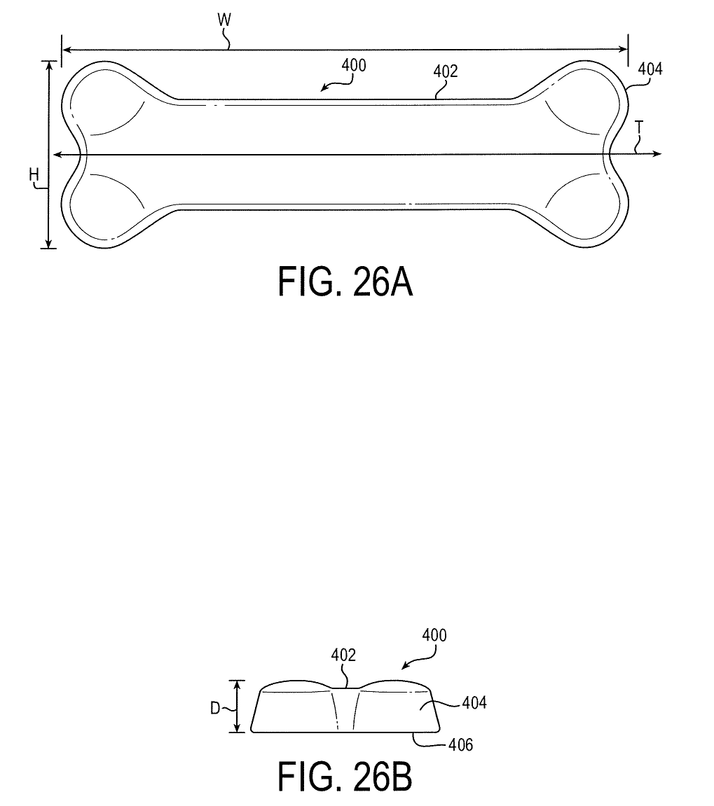

Treats 400 shown in FIGS. 26a, 26b can be randomly released through the dispensing opening 124, 126 of the dispenser 100, 100′, as well as one or more dispensing openings 228, 232, and/or loading opening 218 of dispenser 200. The randomness of treat dispensing relates, in part, to the overall size and shape of the treat 400 relative to the size and shape of the dispensing hole 124, 126, and dispensing openings 228, 232, and/or loading opening 218 of dispenser 200. In addition to the effect of the size and shape of the treats 400 relative to the size and shape of dispensing openings in any dispenser of the invention, the spatial orientation and movement of the treat 400 relative to spatial orientation and movement of the dispenser 100, 100′ and of the dispenser 200 also plays an important role.

Referring generally to FIGS. 1-25c and 27-37, the treat dispenser 100, 100′ and the treat dispenser 200 can be made of an elastic material that is flexible, durable, and resilient, and that can be molded in a manner that promotes bounceability of the treat dispenser 100, 100′ and the treat dispenser 200. The material can be selected and molded to provide specific product safety characteristics including, but not limited to: (1) providing material and structural integrity that poses no potential for injuring a pet's teeth or gums while the material is being chewed by a pet, and (2) providing smooth surfaces without sharp edges or surface that would cut a pet's gums, particularly if the material is broken, torn, or ripped. The material can be selected to be Lead-Free, BPA-Free, non-flammable, or any combination thereof. The material can be sufficiently resilient in order to protect the treats 400 inside the dispenser 100, 100′ and the dispenser 200 from being chewed, crushed, or broken apart by a pet. The material can be selected to be opaque, translucent, or transparent.

Exemplary materials include hard or soft thermoplastics, thermoplastic elastomers (TPE), thermoplastic rubbers (TPR), or thermoplastic polyolefins (TPO); hard or soft natural rubber; silicon; and other materials that are durable, resilient, and flexible. In an embodiment, the TPE material can have a Shore A hardness (as determined by ASTM D-2240) of about 45 to about 70. TPE or other suitable material can selected to float on water. A specific example of TPE material is polystyrene-butadiene-styrene (SBS) (Starprene, Grade B60600F3) which consists of styrene block copolymer (50-60%), polystyrene (15-25%), and mineral oil (15-25%) and has a Shore A hardness of 60.

The characteristics of the material permit the dispenser 100, 100′ to be molded in a single color or multiple colors with or without a distinctive pattern. The material can have a finish ranging from a high gloss to matte. The material can optionally be blended with appealing scents or flavors to enhance engagement.

Referring generally to FIGS. 1-25c and 27-37, the treat dispenser 100, 100′ and the treat dispenser 200 provide a pet with a means for enjoyment whether in individual play or interactive play with its owner or other pets, as well as an outlet for the pet to satisfy the instinctual urge to masticate. The treat dispenser 100, 100′ or treat dispenser 200 can also be used to combat a pet's boredom and also to relieve the pet's anxiety or frustration. The treat dispenser 100, 100′ and the treat dispenser 200 are configured to specifically prolong the length of time a pet engages with the dispenser 100, 100′ and the dispenser 200, whether by way of physical, sensory, and/or cognitive challenge.

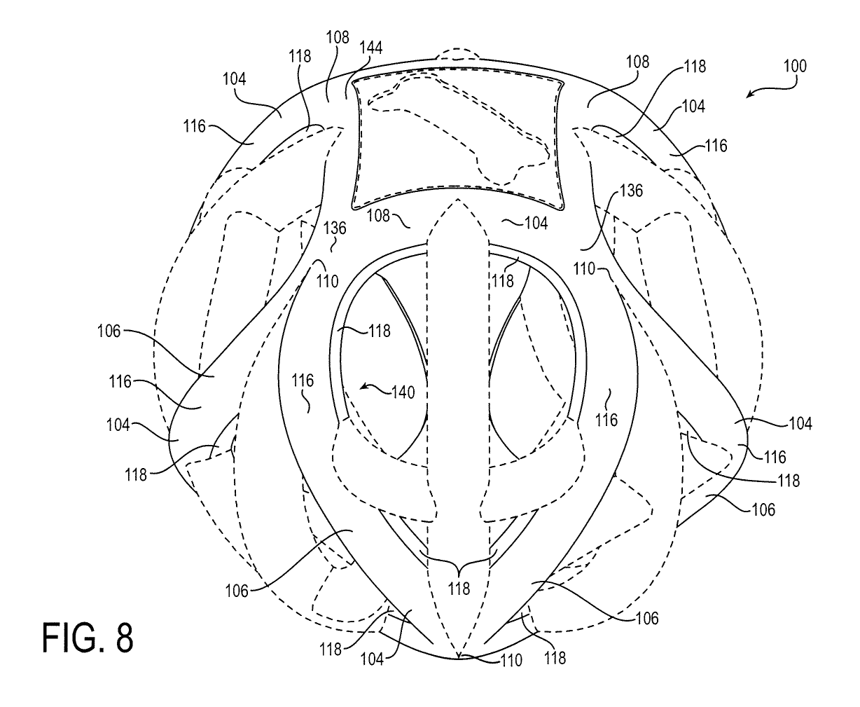

Referring now to embodiments of the invention shown in FIGS. 1-25c, the pet treat dispenser 100, 100′ defines a generally spherical shape having an open framework comprising a continuous segment 104, 104′ that is specifically depicted in FIGS. 8-12 for clarity and generally depicted throughout FIGS. 1-7 and 17-23. The continuous segment 104, 104′ is formed into alternating loops 106, 106′ that extend between polar end caps 128, 128′, whereby each loop 106, 106′ includes an intra-loop member, such as cross member 112, 112′ extending between a lateral surface 118 of the loop 106, 106′.

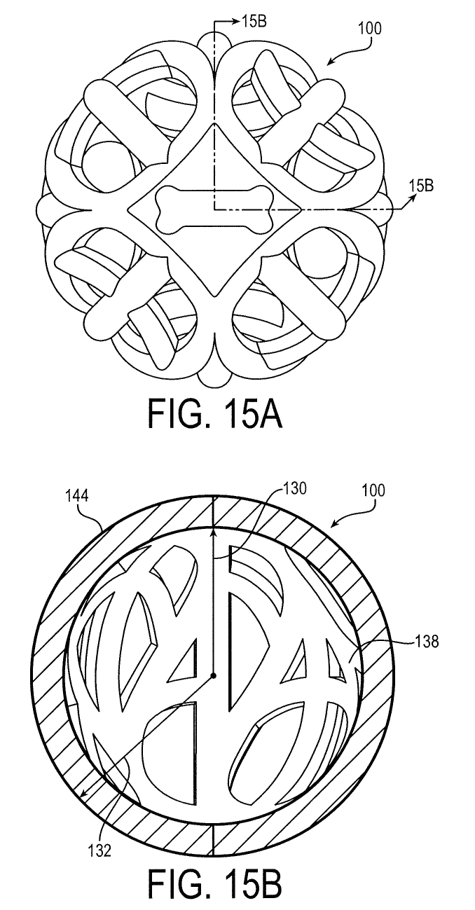

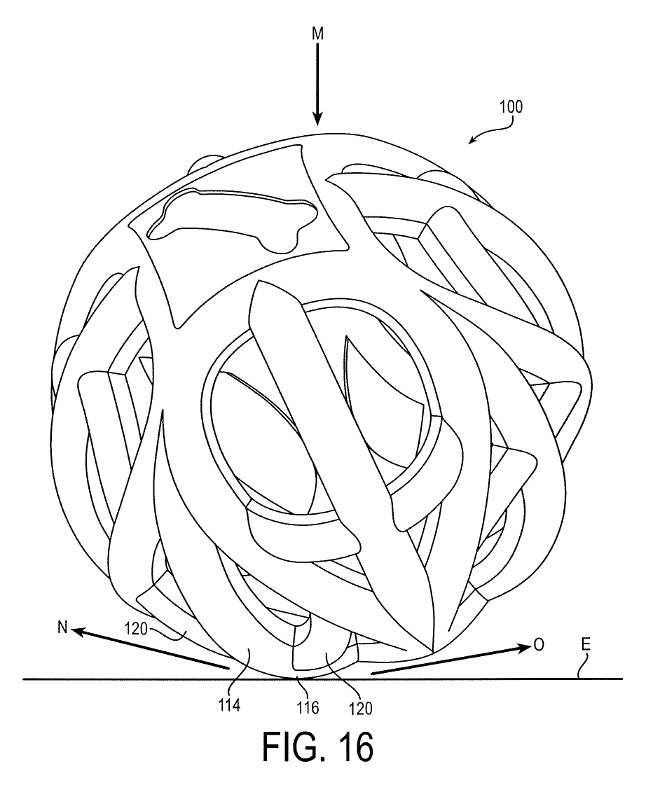

The treat dispenser 100, 100′ includes at least one treat dispensing opening 124, 126, shown for example in FIGS. 1 and 17, defined by a lateral surface 118 of an internal cross member 112, 112′ and a lateral surface 118 of a loop 106, 106′. Continuous segment 104, 104′, cross members 112, 112′, and end caps 128, 128′ include an inner surface 138, 138′ curved substantially along an internal radius of curvature 130, 130′ shown for example in FIG. 15b. This curvature of the inner surface 138, 138′ facilitates ease in molding a unibody structure of, or subparts that are later joined to form, the dispenser 100, 100′.

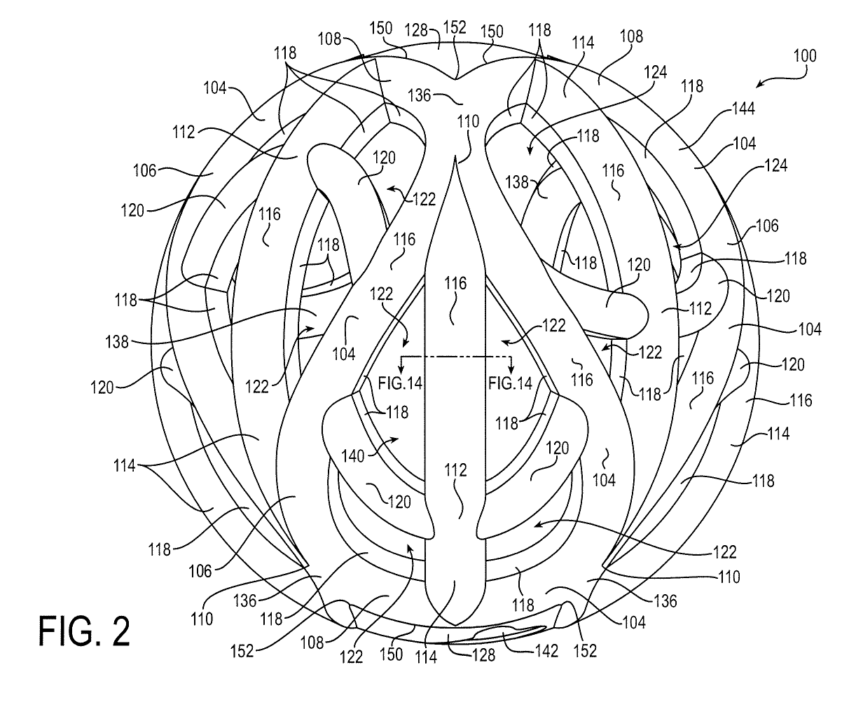

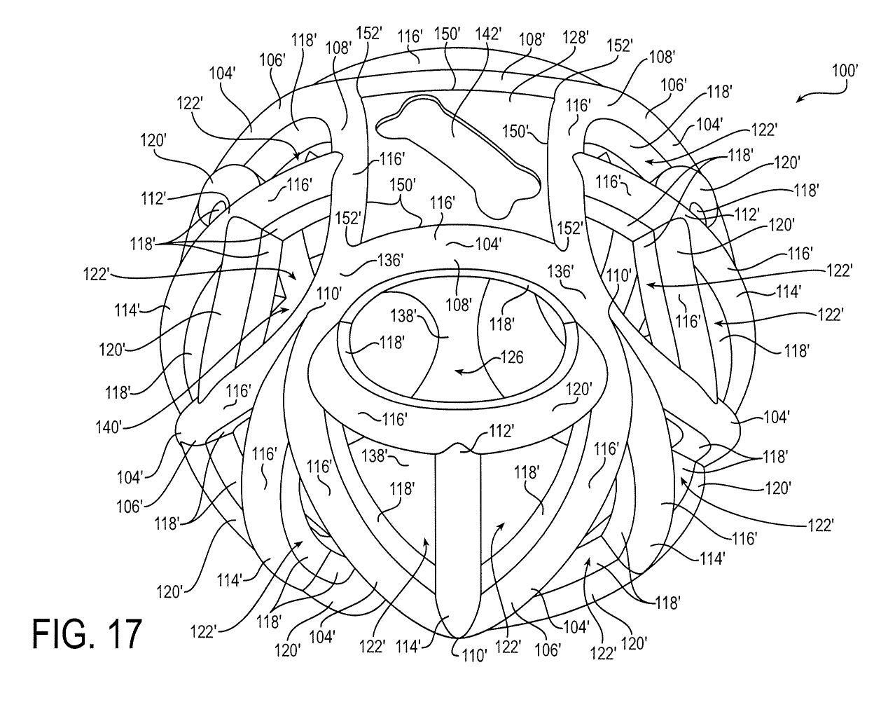

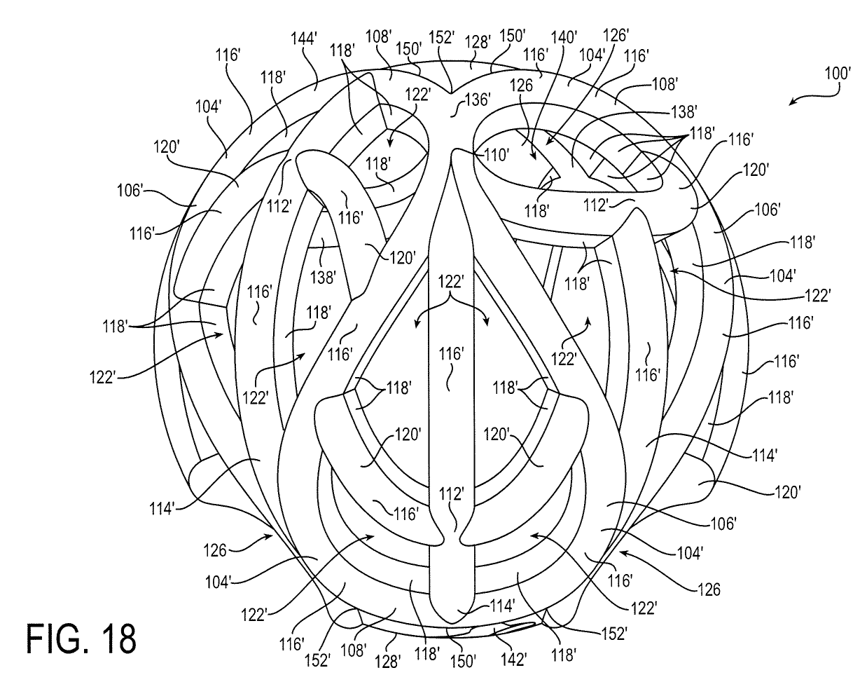

The open framework includes an outer peripheral surface defined by tangential aspects of the rounded surfaces 116, 116′ of the continuous segment 104, 104′ and the cross members 112, 112′, shown for example in FIGS. 2 and 18, and the rounded surfaces 116, 116′ of the external surfaces of the end caps 128, 128′. In the embodiment shown in FIGS. 1-7, the tangential aspects of the rounded surfaces 116 of the continuous segment 104 and the segment 114 of the cross members 112 are arced substantially along an external radius of curvature 132, shown for example in FIG. 15b, of the treat dispensing device 100, while the external surface 144 of the end caps 128 and the arms 120 of the cross members 112 are slightly inset along an external radius of curvature that is smaller than the external radius of curvature 132, but larger than the internal radius of curvature 130 shown in FIG. 15b. In the alternative embodiment shown in FIGS. 17-23, the tangential aspects of rounded surfaces 116′ of the continuous segment 104′, and the arms 120′ and the segment 114′ of each cross member 112′, as well as the external surface 144′ of the end caps 128′, are curved along substantially the same external radius of curvature of the treat dispenser 100′.

Referring to FIGS. 1-12 and 17-23, the sequentially alternating loops 106, 106′ defined by the continuous segment 104, 104′ of the open framework can define any geometric shape useful for forming a generally spherical shape, shown by the embodiments of the treat dispenser 100, 100′, or other three-dimensional shape, such as a cube, oval, cylinder or the like. In the embodiments shown in FIGS. 1-12 and 17-23, the loops 106, 106′ are configured generally in a piriform shape. The loops 106, 106′ can alternatively be in the shape of a tear drop, water droplet, an oval, an ellipsis, an amygdaliform, or other geometric shape.

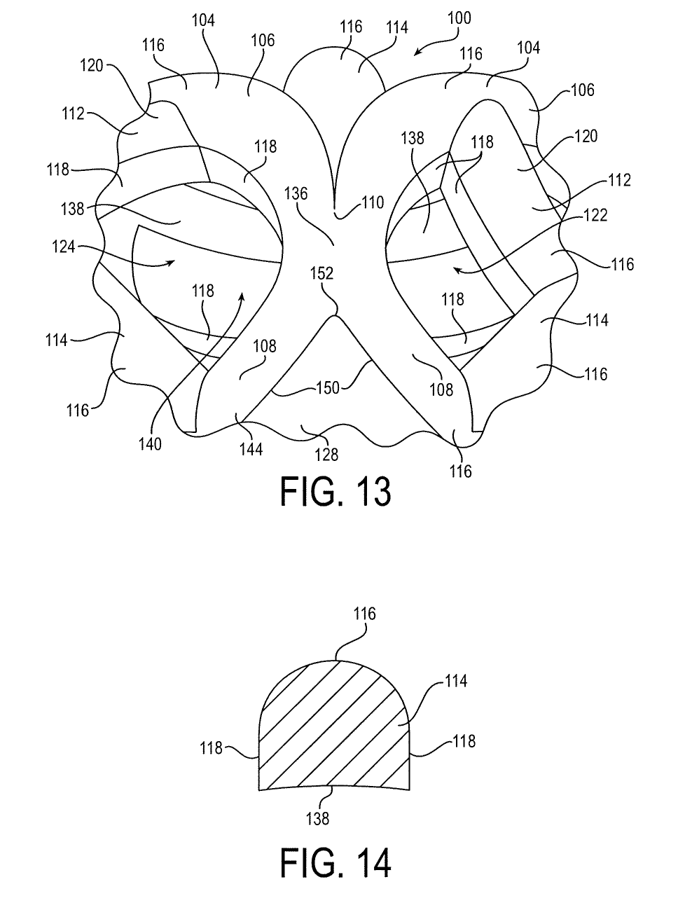

Referring to FIGS. 1-12 and 17-23, piriform-shaped loop 106, 106′ includes a rounded portion 108, 108′ along an aspect of the continuous segment 104, 104′ and an angular convergence portion 110, 110′ where portions of the continuous segment 104, 104′ converge to form an interconnected segment 136, 136′ and then bifurcate, shown specifically for example in FIG. 13, into rounded portions 108, 108′ of adjacent, inverted loops 106, 106′. Aspects of the continuous segment 104, 104′ that form the rounded portions 108, 108′ adjacent the polar ends of the treat dispenser 100, 100′ form a continuous interface with the end caps 128, 128′, which close the open framework at the polar ends of the treat dispenser 100, 100′.

Referring to FIGS. 1-12 and 17-23, the continuous segment 104, 104′ and the cross members 112, 112′ generally consist of a solid material throughout and can have a D-shaped cross section as shown, for example, in FIGS. 2 and 14. The D-shaped cross section includes a rounded surface 116, 116′ that defines an external radius of curvature 132 along the peak of the rounded surface; lateral surfaces 118, 118′ that define apertures and dispensing openings 124, 126; and inner surface 138, 138′ that defined an internal radius of curvature 130 of the dispenser 100, 100′. The continuous segment 104, 104′ and cross members 112, 112′ can be configured with other geometric contours and shapes along their cross sections including round, oval, elliptical, square, rectangular, and the like, as well as any combination thereof. The apertures 122, 122′ permit a pet to grip the dispenser 100, 100′ with its teeth, but not to swallow the dispenser 100, 100′.

Referring again to FIGS. 1-12 and 17-23, the cross members 112, 112′ include a segment 114, 114′ and arms 120, 120′ that extend away from the segment 114, 114′ toward a lateral surface 118 of the loop 106, 106′. The segment 114, 114′ is continuous with the loop 106, 106′ and extends from the convergence portion 110, 110′ of the loop 106, 106′ to generally the center of the lateral surface 118 of the rounded portion 108, 108′ of the loop 106, 106′. The arms 120, 120′ can extend away from the segment 114, 114′ along a curvature, as shown in FIGS. 1-12 and 17-23, or alternatively linearly. The cross members 112, 112′ can be configured in a manner that appears similar to apsi symbol, as shown for example in FIGS. 1-12, or alternatively, a tau symbol as shown for example in FIGS. 17-23. The lateral surface 118, 118′ of cross members 112, 112′ in combination with the lateral surface 118, 118′ of the loops, 106, 106′ define a plurality of apertures 122, 122′ with a cage-like configuration that retains treats 400 within the hollow interior cavity 140, 140′ of the pet treat dispenser 100, 100′.

At least one dispensing opening 124 is provided, for example, with the treat dispenser 100 shown in FIGS. 1-12. The dispensing opening 124 is defined by a lateral surface 118 of a portion of the cross member 112 having arms 120 that extend away from the segment 114 closer to the convergence portion 110 of the loop 106, than the rounded portion 108 of a loop 106 in comparison to loops 106 that do not have dispensing opening 124. In the embodiment shown in FIGS. 1-12, a set of dispensing openings 124 having a general semi-elliptical shape are defined by lateral surfaces 118 of a portion of segment 114 along length DL and lateral surfaces 118 of a portion of loop 106 defined by radius DR. In this embodiment, another set of dispensing openings 124 are also provided on the opposite side of the end cap 128, whereby the treat dispenser 100 includes four dispensing openings 124 in its upper hemisphere. This embodiment also includes two sets of dispensing openings 124 provided in the lower hemisphere of the treat dispenser 124. In alternative embodiments, the number of dispensing openings 124 can be increased or decreased in a manner to optimize the randomness of treat dispensing, e.g., increase or decrease difficulty in random release of treats 400, and the dispensing rate of treats 400 randomly released from the treat dispenser 100. For example, the dispenser 100 could have as little as one dispensing opening 124 and up to 8 dispensing openings 124. Reducing the number of dispensing openings 124, 126 can be accomplished by providing more cross members 112, 112′ that form a cage-like configuration in loop 106, 106′, as shown in FIGS. 1-12 and 17-23, that retains treats 400 in the hollow interior cavity 140.

In a further embodiment, a single dispensing opening 126 is defined by an alternative configuration of a cross member 112′ of dispenser 100′ shown in FIGS. 17-23. In this embodiment, the segment 114′ extends away from the convergence portion 110′ of a loop 106′ and terminates at the arms 120′ which extend away from the segment 114′ generally perpendicularly and then curve toward lateral surface 118′ of the loop 106′. The lateral surfaces 118′ of arms 120′ and part of the lateral surface 118′ of the rounded portion 108′ of the loop 106′ define a generally elliptically-shaped dispensing opening 126. The dispenser 100′ could have as little as one dispensing opening 126 and up to 4 or more dispensing openings 126. In the embodiment shown in FIGS. 17-23, two dispensing holes 126 are provided in the upper hemisphere, and two dispensing holes 126 are provided in the lower hemisphere, of the treat dispenser 100′. In further alternative embodiments, the arms 120′ can be configured in a manner that defines the dispensing opening 126 in alternative geometric shapes.

Referring again generally to FIGS. 1-12 and 17-23, the treat dispenser 100, 100′ can be configured with different shapes and sizes of dispensing openings that provide variable levels of difficulty for randomly releasing treats 400. For example, larger dispensing openings can be used to decrease the difficulty of random release of treats 400 by consequently increasing the dispensing rate of treats 400. Alternatively, smaller dispensing openings can be used to increase the difficulty of random release of treats 400 by consequently decreasing the dispensing rate of treats 400. In a non-limiting embodiment, the treat dispenser 100 may be configured to include at least one dispensing opening 124 and at least one dispensing opening 126. In other non-limiting embodiments, the treat dispenser 100 may have different sized dispensing opening 124, or the treat dispenser 100′ may have different sized dispensing openings 126.

The degree of difficulty of the randomness of release of treats 400 from the dispenser 100, 100′ can also be adjusted by the size and shape of the treat 400 loaded into the dispenser 100, 100′. For example, the difficulty can be increased by loading larger sized treats 400 into the dispenser 100, 100′ which consequently will decrease the dispensing rate of treats 400. Alternatively, the difficulty can be decreased by loading smaller sized treats 400 into the dispenser 100, 100′ which consequently will increase the dispensing rate of treats 400. For example, the treats 400, e.g., the mini, small, medium, and/or large MILKBONE® biscuits, can be loaded into the hollow interior cavity 140, 140′ of the treat dispenser 100, 100′ with the same size of dispensing openings 124, 126. In a further alternative, cube-shaped treats can be loaded into the dispenser 100, 100′. In an even further non-limiting embodiment, different sized treats 400 can be loaded into the hollow interior cavity 140, 140′ of treat dispenser 100, 100′ that is configured with (1) different shapes of dispensing openings, e.g., a combination of dispensing openings 124 and 126, and/or (2) different sizes of dispensing openings, all of which provide a dispenser 100, 100′ with various levels of difficulty for the random release of treats 400.

Referring generally to FIGS. 1-12 and 17-23, the open framework of the dispenser 100, 100′ provides an “open” area defined by the plurality of apertures 122, 122′ of about 25-50% of the dispenser 100, 100′, as measured along the internal radius of curvature 130, while the remaining inner surface 138 of the dispenser 100, 100′ and the associated structure define the “closed” portion of the dispenser 100, 100′. In a non-limiting embodiment, the dispenser 100′ with about a 3-inch external diameter can have an open area of about 45% plus or minus about 5%, and has an open area of about 47% in a specific embodiment. In another non-limiting embodiment, the dispenser 100 having about a 4-inch external diameter has an open area of about 35% plus or minus about 5% and has an open area of about 35% in a specific embodiment. In a further non-limiting embodiment, the dispenser 100 having about a 5-inch external diameter has an open area of about 25% plus or minus about 5%, and has open area of about 29% in a specific embodiment. The aspect ratio of open area to closed area of the dispenser 100, 100′ can range from about 1:1 to about 1:5.

Referring generally to FIGS. 1-12 and 17-23, the dispensing openings 124, 126 are provided with a shape and size for multiple purposes including (1) permitting the loading or inserting of treats 400 into the hollow interior cavity 140 of the dispenser 100, 100′, while also (2) randomly blocking the passage of a treat 400 during use of the dispenser 100, 100′, and (3) randomly dispensing treats 400 with proper alignment of the spatial orientation of the treat 400 relative to the spatial orientation of the dispensing openings 124, 126 of the dispenser 100, 100′.

More specifically, the randomness of the release of the treat 400 from the dispenser 100, 100′ results from the spatial orientation of a treat 400 relative to the spatial orientation of the dispensing openings 124, 126 of the dispenser 100. For example, the longitudinal axis T a treat 400, which has a width W that is larger than the height H and the depth D of the treat 400, must be generally parallel to, or partially offset by about 5-35 degrees from a radial axis of the dispenser 100, 100′ that passes centrally through the dispensing opening 124. In this orientation of the treat 400, the longitudinal axis T of the treat 400 must be generally perpendicular to the dispensing opening 124. Additionally, the treat 400 must also be positioned about its longitudinal axis T so that the height H of the treat 400 is generally parallel to the length DL of the dispensing opening 124, whereby the depth D of treat 400 is also generally parallel to the radius DR of the dispensing opening 124. Furthermore, the treat 400 and the dispenser 100 must be moving or positioned relative to one another so that the treat 400 can pass through the dispensing opening 124 along the radius of the dispenser 100 that is centrally configured through the dispensing opening 124. A similar spatial orientation of treat 400 must occur relative to dispenser 100′ for random release of treats. For example, the longitudinal axis T of treat 400 must aligned with a radius of the dispenser 100′ that is generally perpendicular to a center of the dispensing opening 126. Additionally, the height H of treat 400 must be generally parallel to the major diameter of the dispensing opening 126 and consequently the depth D of the treat 400 would be generally parallel to the minor diameter of the dispensing opening 126. In addition to the spatial orientation of the treat 400, the treat 400 and the dispenser 100 must be moving or positioned relative to one another so that the treat 400 can pass through the dispensing opening 126 along the radius of the dispenser 100 that is central to the dispensing opening 126.

The treat 400 can be a MILKBONE® biscuit shown in FIGS. 26a, 26b. A MILKBONE® biscuit has a general bone shape in different sizes including (1) a mini size having a width W of about one inch, height H of about ½ of an inch, and a depth D of about ⅓ of an inch, whereby the area of an end (e.g., height H by depth D) is about 0.17 inches squared; (2) a small size having a width W of about 1½ inches, height H of about ⅘ of an inch, and a depth D of about ⅖ of an inch, whereby the area of an end is about 0.32 inches squared; (3) a medium size having a width W of about 2½ inches, height H of about one inch, and a depth D of about ⅖ of an inch, whereby the area of an end is about 0.4 inches squared; and (4) a large size having a width W of about 3½ inches, height H of about 1½ inches, and a depth D of about ⅗ of an inch, whereby the area of an end is about 0.9 inches squared. The size and shape of treats 400 can be selected for use with the different embodiments of the dispensing openings 124, 126 provided with different sized dispensers 100, 100′ for example. Other pet treats, chews or food products of various sizes and shapes may be used as treats 400.

Referring generally to FIGS. 1-12 and 17-23, the number of treats 400 loaded into hollow interior cavity 140 of the dispenser 100, 100′ can be within ranges of 1-10, 1-4, or 1-2. This number can vary depending up on the size of the dispenser 100, 100′, as well as the dispensing openings 124, 126, when correlated with the size and shape of the treats 400. For example, a treat dispenser 100 with a 4-inch or 5-inch external diameter, as determined by the external radius of curvature of 132 of the dispenser 100, 100′, can be loaded with 1-3 medium-sized MILKBONE® treats. In this case, the width W of the medium size MILKBONE®, e.g., about 2½ inches, is about 72% of the internal diameter of the 4-inch dispenser 100, e.g., about 3½ inches, and is about 55% of the internal diameter of the 5-inch dispenser 100, e.g., about 3½ inches. These same sizes of dispenser 100 can also be loaded with more than 1-2 mini size or small size MILKBONE® treats 400. The treat dispenser 100′ with a 3-inch external diameter, as determined by the external radius of curvature of 132 of the dispenser 100, 100′, can be loaded with up to 10 small-sized MILKBONE® treats 400. In such a case, the width W of the small size MILKBONE®, e.g., about 1½ inches, is about 55% of the internal diameter of the 3-inch dispenser 100′, e.g., about 2¾ inches. The treats 400 can be easily loaded into the dispenser 100, 100′ through the dispensing openings 124, 126 without having to flex, bend, or twist the material forming the dispensing openings 124, 126.

In non-limiting embodiments, a semi-elliptical dispensing opening 124, shown in FIGS. 1-12, can be provided with pet treat dispensers 100, such as for example a treat dispenser approximately 4-inch or 5-inch diameter as determined by the external radius of curvature of 132 of the dispenser 100, 100′. Any size of MILKBONE® biscuit can be used with dispenser opening 124, 126 to increase or decrease the difficulty of the randomness of the release of treats from the dispenser 100, 100′. The randomness of release can be controlled by the size of the treat 400 relative to the size of the dispensing opening 124, 126. For example, the height H of a treat 400 can be about 50-80% of the length DL of dispensing opening 124 or about 50-80% of the major diameter MJ of dispensing opening 126. Additionally, the depth D of a treat 400 can be about 55-80% of the radius DR of the dispensing opening 126 or about 55-80% of the minor diameter MN of the dispensing opening 126. The difficulty of the random release can be enhanced by increasing the size percentages of the treat 400 relative to the dispensing opening 124, 126, and can conversely be eased by decreasing the size percentages of the treat 400 relative to the dispensing opening 124, 126.

The randomness of release of treats 400 from the dispenser 100, 100′ is also facilitated by the relationship of the area of an end, e.g., height H by depth D, of a MILKBONE® treat 400 to the open area of the dispensing opening 124, 126. The area of an end of a MILKBONE® treat 400 can generally range from about 35 to about 70% of the open area of a dispensing opening 124, 126 or alternatively the open area of the dispensing opening 124, 126 can be about 140 to about 285% of the area of an end of the treat 400. The aforementioned range of percentages can be increased or decreased to adjust the difficulty of the dispensing rate of treats 400 from the dispenser 100, 100′.

In a non-limiting example of dispenser 100 having an external diameter of about 4 inches, the semi-elliptical dispensing opening 124 has (1) length DL of about 1.4 inches along the lateral surface 118 of the segment 114, and (2) radius DR of about 0.6 inches, which define the dispensing opening 124. In this example, the area of the dispensing opening 124 is about 0.65 square inches. A medium size MILKBONE® treat is a suitable size treat 400 for use with this dispenser 100, whereby (1) the height H is about 71% of the length DL; and (2) the depth D is about 66% of the radius DR. Furthermore, the area of an end of the treat 400 is about 62% of the open area of the dispensing opening 124 or alternatively the open area of the dispensing opening is about 160% of the area of the end of the treat 400.

In another non-limiting example of dispenser 100 having an exterior diameter of about 5 inches, a semi-elliptical dispensing opening 124 has (1) length DL of about 1.5 inches, and (2) radius DR of about 0.7 inches. In this example, the area of the dispensing opening 124 is about 0.8 square inches. A medium size MILKBONE® treat is a suitable size treat 400 for use with this dispenser 100, whereby (1) the height H is about 67% of the length DL; and (2) the depth D is about 57% of the radius DR. Furthermore, the area of an end of the treat 400 is about 50% of the open area of the dispensing opening 124 or alternatively the open area of the dispensing opening is about 200% of the area of the end of the treat 400.

In a further non-limiting embodiment of dispenser 100′ having an exterior diameter of about 3 inches, an elliptical dispensing opening 126 has (1) major diameter MJ of about 1.00 inch, and (2) minor diameter MN of about 0.6 inches. In this example, the area of the dispensing opening 126 is about 0.5 square inches. A small size MILKBONE® treat is a suitable size treat 400 for use with this dispenser 100′, whereby (1) the height H is about 80% of the major diameter MJ, and (2) the depth D is about 67% of the minor diameter MN. Indeed, the size and shape of the dispensing opening 124, 126 can be coordinated with the size and shape of the treat 400 so as to permit random dispensing, as well as an increased or decreased rate of dispensing, if desired, of the treat 400 from the treat dispenser 100′. Furthermore, the area of an end of the treat 400 is about 64% of the open area of the dispensing opening 124 or alternatively the open area of the dispensing opening is about 156% of the area of the end of the treat 400.

The aspect ratio of the dimensions of the dispensing opening 124, 126 in relation to the treat 400 can also determine the randomness of the release of treats 400 from the dispenser. The aspect ratio includes the height H and depth D of the treat 400 relative to the dispensing opening 124, 126. For dispenser 100, 100′, the height ratio of the length DL of the dispensing opening 124, as well as major diameter MJ of dispensing opening 126, to the height H of the treat 400, e.g., DL:H, MJ:H, can be, for example, within a range of about 1.1:1 to about 1.5:1, with an average of about 1.2:1. The thickness ratio of the radius DR of the dispensing opening 124, as well as the minor diameter MN of the opening 126, to the depth D of the treat 400, e.g., DR:D, MN:D, can be, for example, within a range of about 1.1:1 to about 1.5:1, with an average of about 1.3:1. These are exemplary, non-limiting aspect ratios that can be increased or decreased based on size and shape of treats 400 relative to the size and shape of dispensing openings 224, 226, as well as alternative configurations of treats and dispensing openings.

Referring generally to FIGS. 1-12 and 17-23, the size of the treat dispenser 100, 100′ is not critical for engagement by a pet. Indeed, pets of all sizes can engage any size of treat dispenser 100, 100′. In a non-limiting embodiment, a treat dispenser 100, 100′ having about a 3-inch external diameter can be provided to a pet, e.g., dog, that weighs up to about 24 pounds. In another non-limiting embodiment, a treat dispenser 100, 100′ having about a 4-inch external diameter can be provided to a pet, e.g., dog, that weighs about 25 to about 49 pounds. In a further embodiment, a treat dispenser 100, 100′ having a 5-inch external diameter can be provided to a pet, e.g., dog, that weighs about 50 to about 110 pounds. Of course, larger dogs could play with smaller sized dispensers 100, 100′ and smaller dogs could play with larger sized dispensers 100, 100′.

Referring generally to FIGS. 1-12 and 17-23, the end caps 128, 128′ close the polar ends of the treat dispenser 100, 100′ between adjacent rounded portions 108, 108′ of the loops 106, 106′ and are continuous therewith. In a non-limiting embodiment, the end caps 128, 128′ are generally square-shaped with arced side surfaces 150, 150′ so that the corners 152, 152′ of the end caps 128, 128′ extend into the curved portions of the continuous segment 104, 104′ that bifurcate opposite the interconnected segments 136, 136′. The internal surface 138 of each end cap 130 is curved along the internal radius of curvature 130 of the treat dispenser 100, 100′. The external surface 144, 144′ of the end caps 128, 128′ can be curved along the external radius of curvature 132, 132′ of the treat dispenser 100, 100′ or may be inset and have a slightly smaller radius of curvature than the external radius of curvature 132, 132′, as shown in the embodiments in FIGS. 1-12 and 17-23. The end caps 128, 128′ provide an external surface 144 in or on which designs and/or logos may be impressed or otherwise presented.

Referring generally to FIGS. 1-12 and 17-23, the hollow interior cavity 140, 140′ of the treat dispenser 100, 100′ is sized in a manner that permits that free, random movement of one or more treats 400 that have been loaded into the treat dispenser 100, 100′ through one or more dispensing holes 124, 126, as the dispenser 100, 100′ moves as it travel through the air when thrown, rolling or bouncing, or being manipulated by a pet as it is being chewed or otherwise manipulated to release treats 400 from the device 100, 100′.

Referring generally to FIGS. 1-12 and 17-23, the material in combination with the shape of the open framework of the dispenser 100, 100′ with end caps 128, 128′ exhibit physical and structural characteristics that provide resiliency, e.g., bounceability, in a manner similar to a closed ball structure, such as a tennis ball or kick ball. When the treat dispenser 100, 100′ is thrown against a generally flat surface E, the impact force causes the continuous segment 104, 104′, cross members 112, 112′, and/or end caps 128, 128 to flex depending upon the point of impact of the dispenser 100, 100′ with the surface E and then return to their original shape, thereby causing the dispenser 100, 100′ to rebound away from the point of impact. Bounceability was assessed by a drop test wherein the pet treat dispenser 100, 100′ was dropped from the height of one meter onto a concrete surface so that the external surface of the end cap 128 would be the point of impact on the concrete surface. The test was conducted inside at ambient air temperature. After being dropped, the initial rebound of the dispensers 100, 100′ was about 35-60% of the drop height, e.g., about ⅖ to about ⅗ of a meter.

Referring to FIG. 16, the unpredictable interaction between the dispenser 100, 100′ and a generally flat surface E, e.g., the random or irregular bounce, depends upon which external aspect(s) of the dispenser 100, 100′ forcibly contacts the surface E. In particular, the “gaps”, e.g., apertures 122, 122′ and dispensing openings 124, 126, in the overall spherical geometry of the dispenser 100, 100′, as well as the rounded surfaces 116, 116′ of the continuous segment 104, 104′ and cross members 112, 112′, enhance the randomness and irregularity of the bounce of the dispenser 100, 100′.

Referring again to FIG. 16, the dispenser 100, 100′ will rebound when forcibly contacting a generally flat surface E, and the point of contact of the continuous segment 104, 104′ or segment 114 will define the randomness or irregularity of the rebound. The dispenser 100, 100′ will randomly or irregularly rebound if the point of contact is not generally tangential to the general spherical shape of the dispenser 100, 100′. For example, the dispenser 100, 100′ will rebound in a manner generally similar to a closed ball if the end caps 128, 128′ of the dispenser 100, 100′ are at the point of impact. However, if the point of impact is at: (1) a portion of a rounded surface 116, 116′ of a continuous segment 104, 104′ that is not tangential to the overall sphere of the dispenser 100, 100′; (2) a portion of a rounded surface 116, 116′ of a segment 114, 114′ or other member of a cross member 112, 112′ that is not tangential to the overall sphere of the dispenser 100, 100′; or (3) any combination thereof, the rounded surfaces 116, 116′ of the continuous segment 104, 104′ and the segments 114, 114′ will cause the dispenser 100, 100′ to rebound in a manner that is unpredictably random and irregular, particularly when compared to the bounce of a closed ball or spherical structure.

Referring again to FIG. 16, when striking a generally flat surface E at a trajectory M that is generally perpendicular to the flat surface E, the dispenser 100, 100′ can rebound at any variety of angles N, 0 from the point of impact, such as shown in FIG. 16. If the dispenser 100, 100′ is static, e.g., not rotating about its center point, during its aerial travel, a non-tangential initial contact with a surface E will cause the dispenser 100, 100′ to rebound irregularly and to begin to rotate after rebounding. If the dispenser 100, 100′ is dynamic, e.g., rotating about its center point during aerial travel, this increases the likelihood of a non-tangential initial point of contact and an irregular rebound. In either case, static or dynamic, the dispenser 100, 100′ will continue to bounce randomly at points of contact on its external surface and either maintain or alter any rotation during flight after the rebound. Each rebound could occur in a plurality of different angles N, 0 from the surface E depending upon which a portion of the rounded surface 116, 116′ of the continuous segment 104, 104′ or segment 114, 114′ is at the point of impact. This promotes unpredictable physical interaction between the dispenser 100, 100′ with the generally flat surface E until gravity or a pet or human brings the bouncing dispenser 100, 100′ to rest.

The unpredictable interaction, e.g., random bounce, of the dispenser 100, 100′ stimulates physical engagement by a pet. This unpredictability is further enhanced if a human or pet seeks to intercept a dispenser 100, 100′ to control its spatial movement. Furthermore, if treats 400 are loaded into the dispenser 100, 100′, then the treats 400 will randomly contact the inner surface 138, 138′ of the dispenser 100, 100′ and freely and randomly bounce within the hollow interior cavity 140, 140′, as the dispenser 100, 100′ is randomly bouncing against, and rebounding from, the surface E. A treat 400 can randomly exit through a dispensing hole 124, 126 if the treat 400 is in an orientation that permits passage of the treat 400 through the dispensing hole 124, 126 while the dispenser 100, 100′ is bouncing. The possibility of releasing a treat 400 further enhances pet engagement with the dispenser 100, 100′.

The unpredictability of the treat dispenser is also presented when the treat dispenser 100, 100′ rolls on a generally flat surface E. For example, the overall spherical shape of the treat dispenser 100, 100′ promotes a generally linear rolling pathway along a generally flat surface E at a relatively high frequency of revolution of the dispenser 100, 100′. While rolling at a high rate of speed, the revolutions of the dispenser 100, 100′ present a generally consistent “spherical” body rolling along the surface E. However, as the rolling treat dispenser 100, 100′ decelerates, the unpredictability of the treat dispenser's 100, 100′ interaction with the surface E becomes more prominent. More specifically, as gravity works to slow the roll of the treat dispenser 100, 100′ to a stop, the dispenser 100, 100′ will roll less linearly as it randomly bounces along the surface E when the “flat spots” or “gaps” of the general sphere, e.g., apertures 122 and dispensing openings 124, 126, are more exposed to the flat surface E and gravity promotes the dispenser 100, 100′ to fall into the “flat spot” or “gaps” while rolling. In other words, the randomness of the bounce during rolling will occur and increase in frequency when the revolutions of the dispenser 100, 100′ decrease and the generally spherical nature of the dispenser 100, 100′, which is prominent during high frequency of revolutions, gives way to a higher frequency of the “flat spots” or “gaps” interacting with the flat surface E. The randomness of the bounce of the dispenser 100, 100′ will continue to increase until gravity brings the dispenser 100, 100′ to rest on a “flat spot” or “gap”.

The unpredictability of the dispenser's 100, 100′ interaction with a generally flat surface E can stimulate a pet to physically engage the dispenser 100, 100′. If treats 400 are loaded into the dispenser 100, 100′, then the treats 400 will randomly contact the inner surface 138, 138′ of the dispenser 100, 100′ and freely and randomly bounce within the hollow interior cavity 140, 140′, as the dispenser 100, 100′ is rolling. A treat 400 can randomly exit through the dispensing holes 124, 126, if the treat 400 is in an orientation that permits passage of the treat 400 through the dispensing holes 124, 126, while the device 100, 100′ is rolling.

The treat dispenser 100, 100′ can also be manipulated by a pet as it controls spatial movement of dispenser 100, 100′ with its legs, paws, nose, and/or teeth. The dispenser 100, 100′ visually presents the treats 400 which emit a scent that entices the pet to obtain the treats 400. Because the structure of the dispenser 100, 100′ and its material composition allow the dispenser 100, 100′ to be chewed on, while protecting the treats 400 from being crushed as a pet chews on the dispenser 100, 100′, this challenges a pet to manipulate the dispenser 100, 100′ so that at least one treat 400 falls out of the dispenser 100, 100′ through a dispensing opening 124, 126. This challenge prolongs a pet's cognitive engagement with the dispenser 100, 100′ because the pet must continue to physically manipulate the dispenser 100, 100′ to cause it to randomly release treats 400. Multiple treats 400 loaded in the dispenser 100, 100′ will further prolong a pet's engagement with the dispenser 100, 100′ until the pet either tires from playing with the dispenser 100, 100′ or causes the release of some or all treats 400 loaded in the dispenser 100, 100′.

Referring generally to FIGS. 1-12 and 17-23, the treat dispenser 100, 100′ can be manufactured using various molding techniques that include use of core molding and pull-out molding to form a unibody construction, as well as molding of subparts that are later adhered, chemically fused or heat sealed together along mating surfaces, e.g., curvilinear surface CS1, to form the dispenser 100, 100′. For example, the top portion TP can be adhered by a solvent bond to the bottom portion BP, and the left portion LP can be adhered by a solvent bond to the right portion RP, using a long cure adhesive (DongGuan, JT-499A-2) that permits adjustment of the corresponding portions for proper alignment.

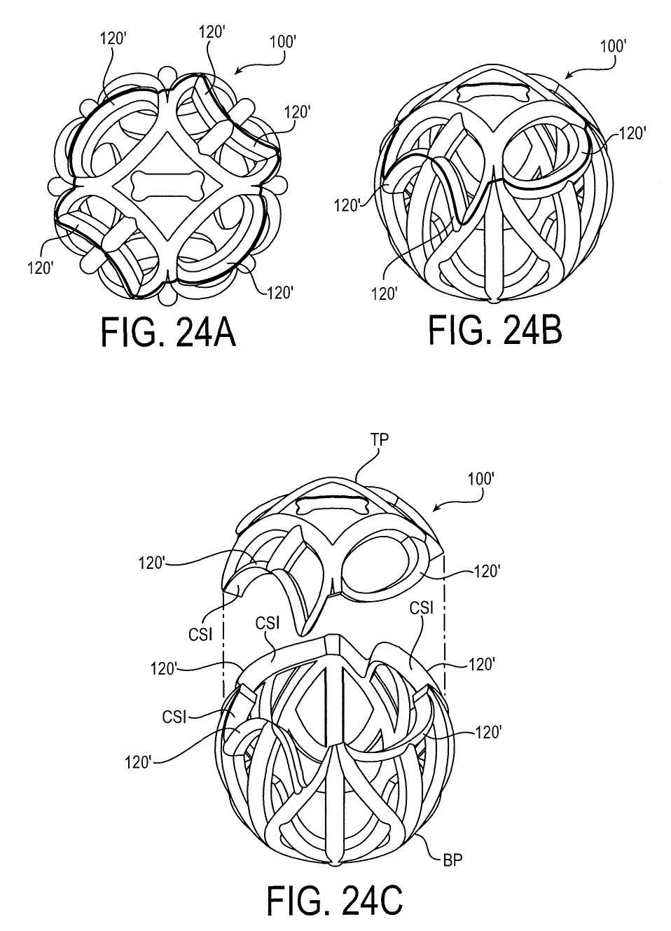

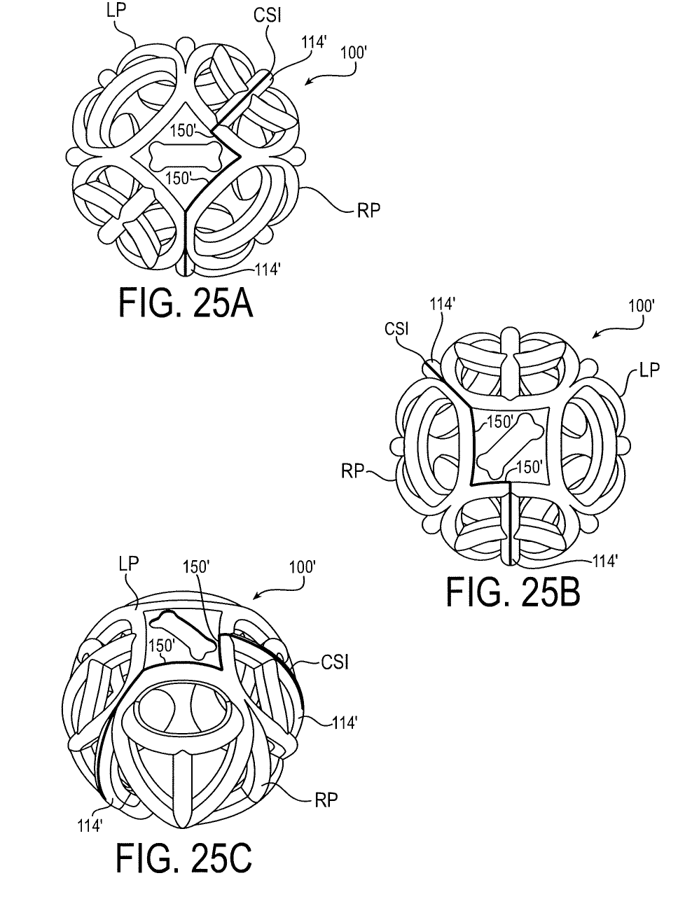

For example, the dispenser 100, 100′ can be molded in two parts that are joined together along a joining interface formed by mating curvilinear surfaces CS1 that may have mating curvilinear surfaces, corresponding lap joint surfaces, corresponding projections and recesses, channels and prongs, or other surface mating interface that promotes joining of the two subparts to form a generally spherical dispenser 100, 100′. The two parts may be halves that are joined horizontally along an equator, or vertically along generally symmetrical halves of segments 114, 114′ and end caps 128, 128′. In an alternative embodiment, the two subparts may be ⅓ and ⅔ portions of the dispenser 100, 100′ that are joined together. Referring now to FIGS. 24a-24c, a top portion TP and a bottom portion BP may be joined along corresponding curvilinear surfaces CS1, whereby the joining of the surfaces forms the arms 120, 120′ of the cross members 112, 112′ and corresponding portions of the loops 106, 106′. Alternatively, and referring to FIGS. 25a-25c, a left (⅓) portion LP and a right (⅔) portion RP may be joined along corresponding surfaces between the segments 114, 114′ and lateral aspects of the end caps 130, 130′ and lateral aspects of the rounded portions 108, 108′ of the loops 106, 106′ at the polar ends of the dispenser 100, 100′. Other configurations of subparts can be used to form the dispenser 100, 100′.

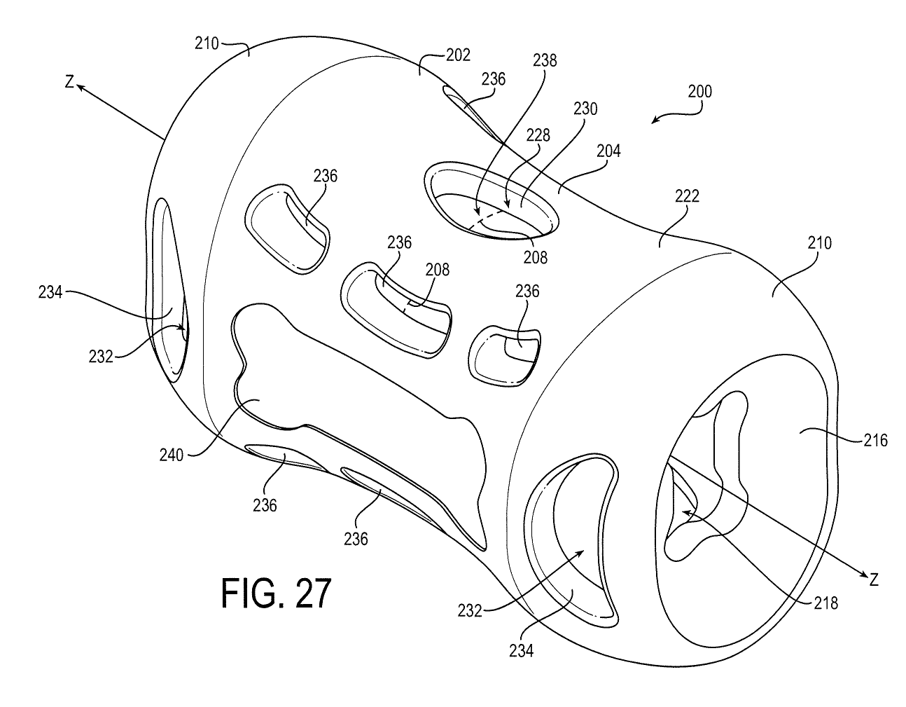

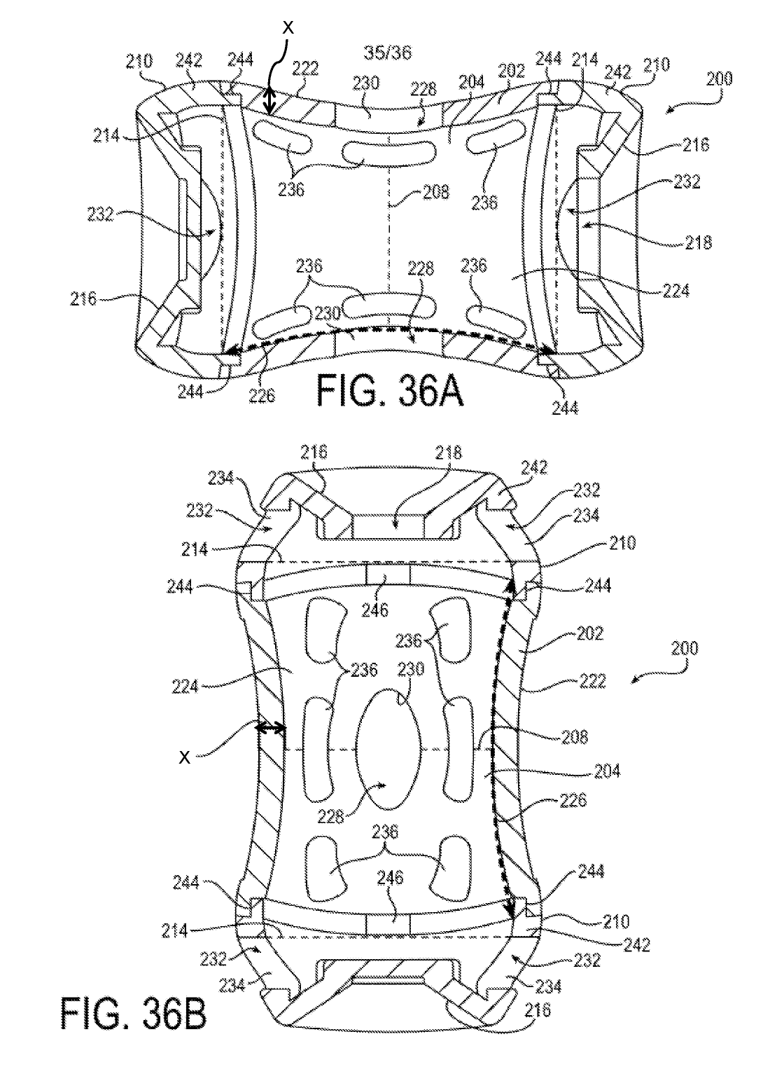

Referring to another embodiment of the invention shown in FIGS. 27-37, the treat dispenser 200 is provided and comprises a wall 202 that defines a shaft 204 with lobed ends 210 at ends of the shaft 204, whereby the dispenser 200 includes a hollow interior cavity 238. Although not critical, the wall 202 in the embodiment shown in FIGS. 27-37 has a substantially similar thickness X shown in FIGS. 36a, 36b, but alternative embodiments can have varying thicknesses along any aspect of the wall 202. For example, upper and lower portions of the shaft 204 may be thicker than the rest of the wall 202 forming the shaft 204 in order to provide weight to promote momentum as the dispenser 200 rolls. The wall 202 has a first internal perimeter 208 defined centrally along the shaft 204 by the internal surface 224. The wall 202 includes second internal perimeters 214 that are defined by internal surface 224 of the lobed ends 210. Referring to FIGS. 36a, 36b, the internal surface 224 is generally arced along a curved surface 226 that extends laterally away from the first internal perimeter 208 of the shaft 204 to the second internal perimeters 214 in the lobed ends 210. In alternative configurations, the shaft 204 may be generally cylindrical.

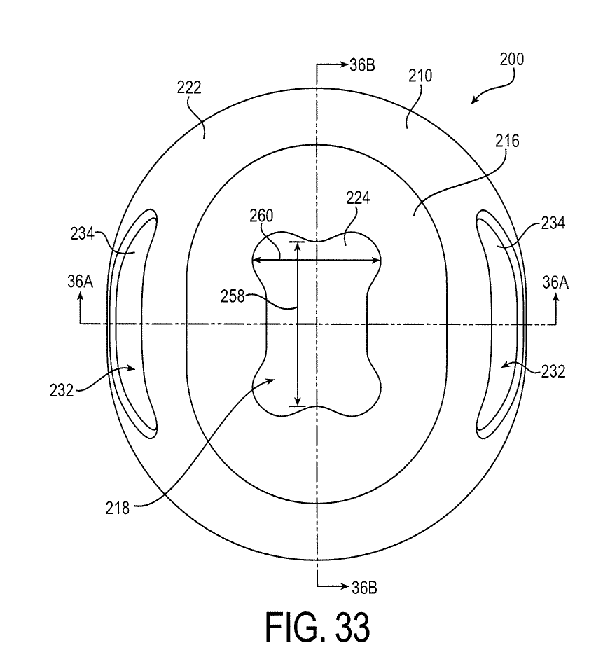

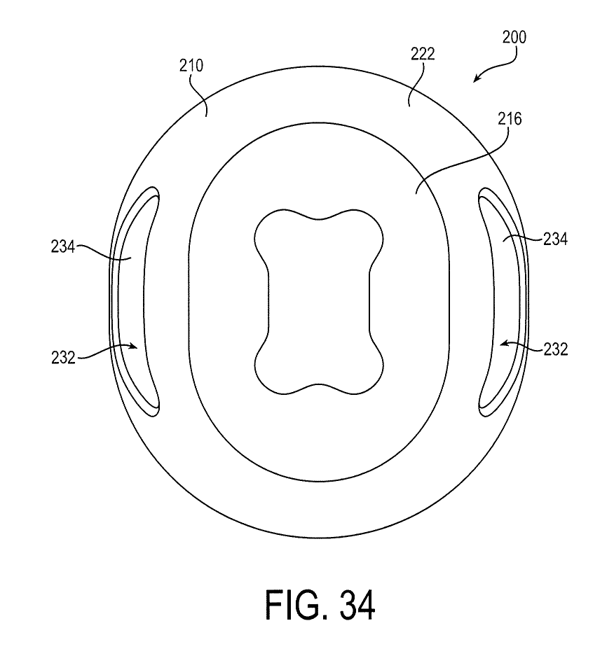

Referring to FIGS. 27-37, the treat dispenser 200 has a generally elliptical exterior surface 222 around its longitudinal axis Z. The elliptical exterior surface 222 is shown particularly by side views in FIGS. 33, 34. In alternative embodiments, the dispenser 200 may have a cross section that is round, oval or other geometric shape with curved surfaces that promote rolling of the dispenser 200 around its longitudinal axis Z.

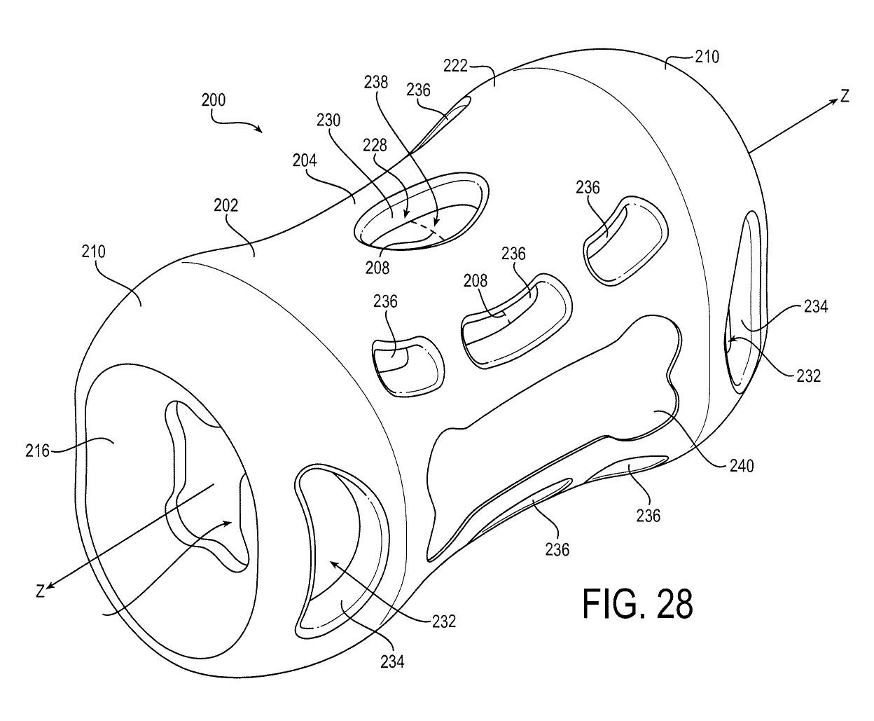

The lobed ends 210 include lateral surfaces 216 that may be concave as shown in FIGS. 27, 28, but may alternatively be flat or convex. The lobed end 210 in FIG. 28 is closed along a first end of the dispenser 200, but the opposing lobed end 210 shown in FIG. 27 has a loading hole 218 that permits passage of treats 400 into and out of the hollow interior cavity 238 of the dispenser 200. In FIG. 27, the loading hole 218 is generally in the shape of a bone, but alternative embodiments of the loading hole 218 can be another geometric shape, such as a slot, a circle, an ellipsis, an oval or other geometric shape. The primary purpose of the loading hole 218 is to provide the capability for easily loading treats 400 into the hollow interior cavity 238 of the dispenser 200. Treats 400 can be easily loaded through the loading hole 218 in various orientations without having to flex, bend, or twist the material. The concave lateral surface 216 in combination with the shape and position of the loading hole 218 on the lateral surface 216 substantially retains treats 400 inside the cavity 238 as the treats 400 are moving randomly within the dispenser 200 during use. In a further embodiment, the lobed ends 210 are both closed, e.g., there is no loading hole 218, and the treats 400 can be loaded through dispensing holes 228; and/or dispensing holes 232 into the hollow interior cavity 238, as provided in various configurations of the dispenser 200.

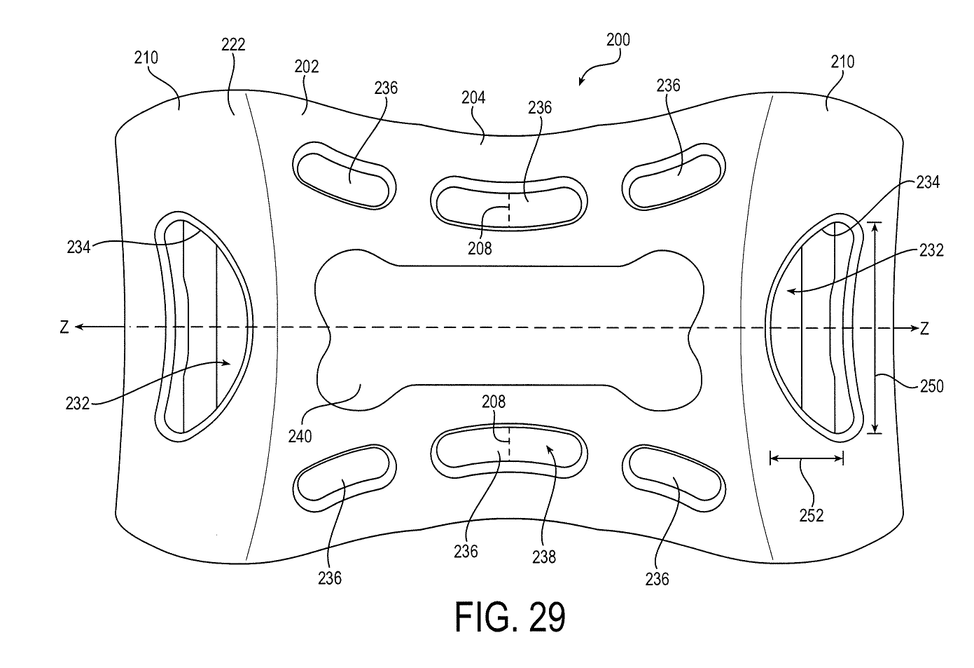

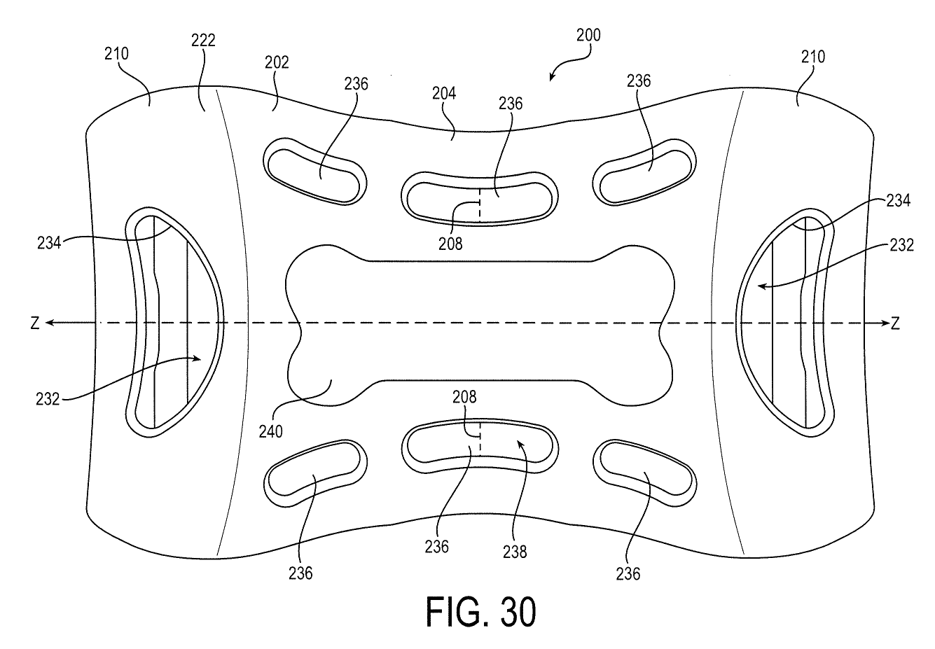

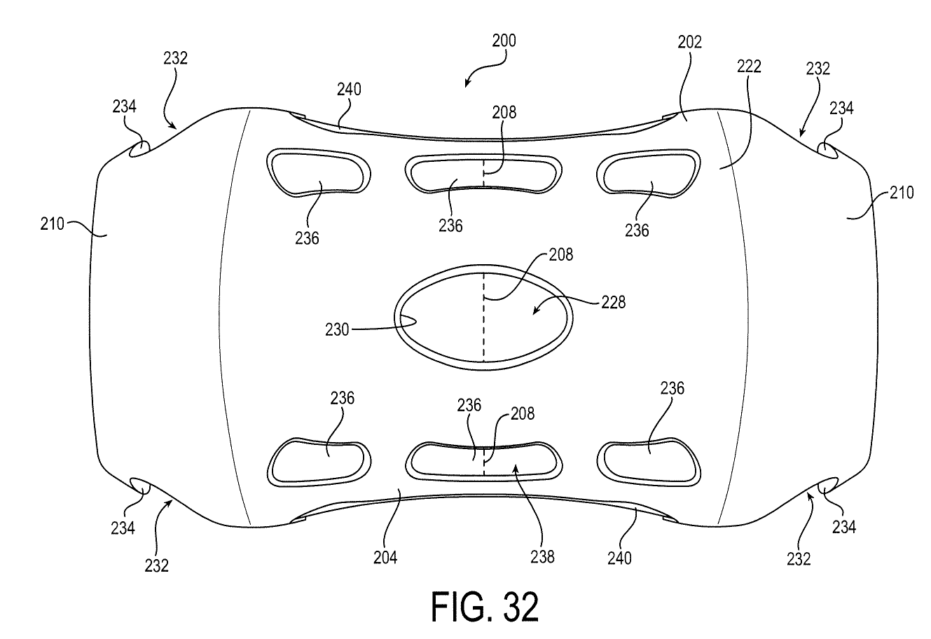

Referring to FIGS. 27-37, the treat dispenser 200 includes at least one dispensing hole 228 defined by surface 230 of wall 202 or dispensing hole 232 defined by surface 234 of wall 202 to permit the random release of treats 400 from the hollow interior cavity 238 of the dispenser 200. The dispensing hole 228 can be elliptical as shown for example in FIGS. 27-28, 32-33, or the dispensing hole 232 may be arcuate as shown in FIGS. 27-30 so long as each is sized and shaped to permit passage of a treat 400 in a limited number of spatial orientations of the treat 400 relative to the dispensing holes 228 or 232, while functioning to generally retain the treats 400 inside the hollow interior cavity 238 of the dispenser 200. FIGS. 32-33 show that elliptically-shaped dispensing holes 228 are generally centrally located along the shaft 204 through the upper and lower portion of the shaft 204. Additionally, FIGS. 29-30 show arcuate dispensing holes 232 provided laterally in the front and rear surfaces of the lobed ends 210 of the dispenser 200.

In further alternative configurations of the dispenser 200, the dispensing holes may have a different geometric shape so long as each is sized and shaped relative to the treat 400 to permit passage of a treat 400 from the hollow interior cavity 238 in a limited number of spatial orientations of the treat 400 relative to the dispensing holes 228 and/or 232, while contemporaneously functioning to generally retain the treats 400 inside the hollow interior cavity 238 of the dispenser 200.

The randomness of release of the treats 400 from the dispenser 200 is similar to that for dispenser 100, 100′, whereby treats 400 are randomly released from the dispenser 200 based on the spatial orientation of the treat 400 relative to the spatial orientation of the dispenser. For example, a treat 400 can be randomly released from the dispenser 200 if the longitudinal axis T is generally aligned perpendicularly to the center of the loading opening 218, the elliptical dispensing opening 228, or the arcuate dispensing opening 232. In addition to the alignment of the longitudinal axis T, the treat 400 must also be positioned about its longitudinal axis T so that the height H is generally parallel along (1) the height 258 of the loading opening 218, (2) the major diameter 256 of the elliptical dispensing opening 228, or (3) the major length 250 of the arcuate dispensing opening 232. The randomness is impacted by the movement or position of the treat 400 relative to the movement or position of the dispenser 200.

Any number or configuration of the dispensing holes can be provided in alternative embodiments. For example, the arcuate dispensing holes 232 and/or the elliptical dispensing holes 228 may be provided in any number of non-limiting configurations. If only elliptical dispensing holes 228 are provided with the dispenser 200, then there may be one to 4 or more elliptical dispensing holes 228 provided through the upper, lower, front and/or rear of the central aspect of the shaft 204. If just arcuate dispensing holes 232 are provided with the dispenser 200, then there may be one to 4 or more arcuate dispensing holes 232 provided through the upper, lower, front and/or rear of one or both of the lobed ends 210. In a non-limiting example, an arcuate dispensing hole 232 may be provided through the front or rear of one or both of the lobed ends 210 of the dispenser 200. In another example, an arcuate dispensing hole 232 may be provided through the top or bottom of one or both of the lobed ends 210 of the dispenser 200. In a further example, an arcuate dispensing hole 232 may be provided through the front of one or more lobed ends 210 of the dispenser 200 and one arcuate dispensing hole 232 may be provided through the rear of one or more lobed ends 210. In yet a further embodiment, one or more elliptical dispensing holes 228 or other geometrically-shaped dispensing holes may be provided through one or both of the lobed ends 210 of the dispenser 200.

Referring to FIGS. 27-37, the treat dispenser 200 may optionally include one or more gripping holes 236 provided along the front and rear of the shaft 204 of the dispenser 200, or alternatively along other portions of the shaft 204 and/or lobed ends 210 of the dispenser 200. The gripping holes 236 allow a pet to secure the dispenser 200 by holding the gripping holes 236 with the pet's teeth. The gripping holes 236 also allow a pet to see and smell treats within the hollow interior cavity 238 of the dispenser 200. The gripping holes 236 can be provided in any geometric shape so long as the gripping holes 236 are sized in a manner that prevents passage of the treats 400 out of the hollow interior cavity 238 of the dispenser 200.

Referring to FIGS. 27-32, 35, the hollow interior cavity 238 of the dispenser 200 is sized in a manner that permits the random movement of one or more treats 400 loaded into the dispenser 200 through one or more dispensing holes 228 and/or 232, as the dispenser 200 is traveling through the air when thrown, rolling or bouncing on a surface, or being manipulated and/or chewed by a pet. For example, the width W of a MILKBONE® treat 400 that can be used with dispenser 200, e.g., mini size or small size, can be (1) about 35-70% of the internal surface 224 of the dispenser 200 along the major diameter J of the lobed ends 210, e.g., about 2.5 inches; (2) about 40-80% of the internal surface 224 of the dispenser 200 along the minor diameter K of the lobed ends 210, e.g., about 2.2 inches; and (3) about 20-45% of the internal surface 224 of the dispenser 200 along its longitudinal axis Z, e.g., about 4.25 inches.

The treat dispenser 200 includes sufficient space on its external surface 222 for designs and/or logos to be impressed into or extend from the external surface 222 as shown in FIGS. 27-32.

The randomness of release of treats 400 from the dispenser 200 is facilitated by the relationship of the area of an end, e.g., height H by depth D, of a MILKBONE® treat 400 to the open area of the dispensing holes 228, 232 and of the loading opening 218. The area of an end of a MILKBONE® treat 400 can generally range from about 20 to about 50% of the open area of the dispensing holes 228, 232 or of the loading opening 218, or alternatively the open area of the dispensing holes 228, 232 or of the loading opening 218 can be about 200 to about 500% of the area of an end of the treat 400. The aforementioned range of percentages can be increased or decreased to adjust the difficulty of the dispensing rate of treats 400 from the dispenser 200.

In a non-limiting example, the dispenser 200 has an external length of about 4 inches along its longitudinal axis Z, and each lobed end 210 has a major external diameter J of about 2.5 inches and a minor external diameter K of about 2.2 inches at the greatest external perimeter of each lobed end 210. In this embodiment, each arcuate dispensing hole 232 has a height of about 1.1 inches and a width of about 0.45 inches, thereby defining an open area of approximately 0.4 square inches. In this embodiment, the area of an end of the treat 400 is about 34% of the open area of the dispensing hole 232 or alternatively the open area of the dispensing hole 232 is about 294% of the area of the end of the treat 400. Each elliptical dispensing hole 228 has a length of about 1.0 inches and width of about 0.55 inches, thereby defining an open area of approximately 0.4 square inches. In this embodiment, the area of an end of the treat 400 is about 43% of the open area of the dispensing hole 228 or alternatively the open area of the dispensing hole 228 is about 232% of the area of the end of the treat 400. The loading hole 218, which has a bone-shaped conformation, has a height of about 1.0 inch and a width of about 0.6 inches, thereby defining an open area of about 0.6 square inches. In this embodiment, the area of an end of the treat 400 is about 28% of the open area of the loading hole 218 or alternatively the open area of the loading hole 218 is about 357% of the area of the end of the treat 400.

In another non-limiting example, the dispenser 200 has a length of about 4.9 inches along its longitudinal axis Z, and each lobed end 210 has a major diameter J of about 2.9 inches and a minor diameter K of about 2.6 inches at the greatest external perimeter of each lobed end 210. In this embodiment, each arcuate dispensing hole 232 has a height of about 1.3 inches and a width of about 0.45 inches, thereby defining an open area of approximately 0.5 square inches. In this embodiment, the area of an end of the treat 400 is about 43% of the open area of the dispensing hole 232 or alternatively the open area of the dispensing hole 232 is about 294% of the area of the end of the treat 400. Each elliptical dispensing hole 228 has a length of about 1.0 inches and width of about 0.55 inches; thereby defining an open area of approximately 0.4 square inches. In this embodiment, the area of an end of the treat 400 is about 43% of the open area of the dispensing hole 228 or alternatively the open area of the dispensing hole 228 is about 232% of the area of the end of the treat 400. The loading hole 218, which has a bone-shaped conformation, has a height of about 1.0 inches and a width of about 0.6 inches, thereby defining an open area of about 0.6 square inches. In this embodiment, the area of an end of the treat 400 is about 28% of the open area of the loading hole 218 or alternatively the open area of the loading hole 218 is about 357% of the area of the end of the treat 400.

A mini size MILKBONE® treat can be used with the dispenser 200, whereby: (1) the height H of the treat 400 is about 50% of the major diameter 256 of the dispensing opening 228, about 84% of the height 250 of the dispensing opening 232, and about 50% of the height 258 of the loading opening 218; and (2) the depth D of the treat 400 is about 60% of the minor diameter 254 of the dispensing opening 228, about 60% of the width 252 of the dispensing opening 232, and about 55% of the width 260 of the loading opening 218.

The aspect ratio of dispensing opening 228, 232, as well as loading opening 218, to the treat 400 facilitates the randomness of the release of treats 400 from the dispenser 200. The aspect ratio includes the height H and depth D of the treat 400 relative to the dispensing opening 228, 232 and loading opening 218. For the dispensing opening 228 that is elliptical, the ratio of the length 256 of the dispensing opening 228 relative to the end height H of the treat 400 can be, for example, within a range of about 1.7:1 to about 2.2:1, with an average of about 1.9:1. The ratio of the width 254 of the dispensing opening 228 relative to the depth D of the treat 400 can be, for example, within a range of about 1.4:1 to about 1.8:1, with an average of about 1.6:1. For the dispensing opening 232 that is arcuate, the ratio of the height 250 of the dispensing opening 232 relative to the end height H of the treat 400 can be, for example, within a range of about 2.2:1 to about 2.6:1, with an average of about 2.4:1. The ratio of the width 252 of the dispensing opening 228 relative to the depth D of the treat 400 can be, for example, within a range of about 1.1:1 to about 1.5:1, with an average of about 1.3:1. For the loading opening 218 that is bone-shaped, the ratio of the height 258 of the dispensing opening 218 relative to the end height H of the treat 400 can be, for example, within a range of about 1.6:1 to about 2:1, with an average of about 1.8:1. The ratio of the width 260 of the dispensing opening 218 relative to the depth D of the treat 400 can be, for example, within a range of about 1.5:1 to about 1.9:1, with an average of about 1.7:1. These are exemplary, non-limiting aspect ratios that can be increased or decreased based on size and shape of treats 400 relative to the size and shape of dispensing openings 228, 232, as well as loading opening 218, and alternative configurations of treats and dispensing openings.

Indeed, the size and shape of the dispensing opening 228, 232 can be coordinated with the size and shape of the treat 400, e.g., mini MILKBONE® or small MILKBONE®, so as to permit random dispensing, as well as an increased or decreased rate of dispensing, if desired, of the treat 400 from the treat dispenser 200.

The size of the treat dispenser 200 is not critical for engagement by a pet. Indeed, pets of all sizes can engage any size of treat dispenser 200. In a non-limiting example, the treat dispenser 200 having about a 4-inch length along its longitudinal axis Z can be provided to a pet, e.g., a dog, having a weight of up to about 24 pounds. In another non-limiting example, the treat dispenser 200 having about a 4.9-inch length along its longitudinal axis Z can be provided to a pet, e.g., dog, having a weight of about 25-49 pounds. Of course, smaller sized dogs can play with larger sized treat dispensers 200, and larger sized dogs can play with smaller sized treat dispensers 200.

The material in combination with the shape of the wall 202 configured as a shaft 204 with lobed ends 210 provides physical and structural characteristics that provide the dispenser 200 with an unpredictable interaction with a generally flat surface E. For example, the dispenser 100 will bounce with a resiliency similar to that of a closed ball structure, such as a tennis ball or kick ball. If, however, the dispenser 200 is forcibly thrown against, or dropped on, a generally flat surface E, the impact force will cause the wall 202 of the dispenser 200 to flex at the dispenser's 200 point of impact with the surface E and then to return to its original shape, thereby causing the dispenser 200 to rebound away from its point of impact with the surface E. The unpredictability of the rebound trajectory depends on which external aspect(s) of the dispenser 200 contacted the surface E. For example, when striking a generally flat surface E, the curved surfaces of the lobed ends 210 of the dispenser 200 could rebound at any variety of angles from the point of impact or even cause the dispenser 200 to rotate about the longitudinal axis Z or other axis of the dispenser 200. Thereafter, as the dispenser 200 continues to bounce, each rebound could occur at a plurality of different angles from the surface depending upon which portion(s) of the curved external surface 222 of the dispenser 200 is at the point of impact, thereby creating an unpredictable interaction with the surface E until gravity or a human or pet causes the dispenser 200 to rest.

The bounce functionality stimulates physical engagement by a pet which may work to gain physical control of the dispenser 200 to stop it from bouncing. If treats 400 are loaded into the dispenser 200, then the treats 200 will randomly contact the inner surface 224 of the hollow interior cavity 238 of the dispenser 200 and freely and randomly bounce within the hollow interior cavity 238, as the dispenser 200 is bouncing against the flat or other surface. A treat 400 can randomly exit through the dispensing holes 228 and/or 232 if the treat 400 is in an orientation that permits passage of the treat 400 through the dispensing holes 228 and/or 232 while the dispenser 200 is bouncing.

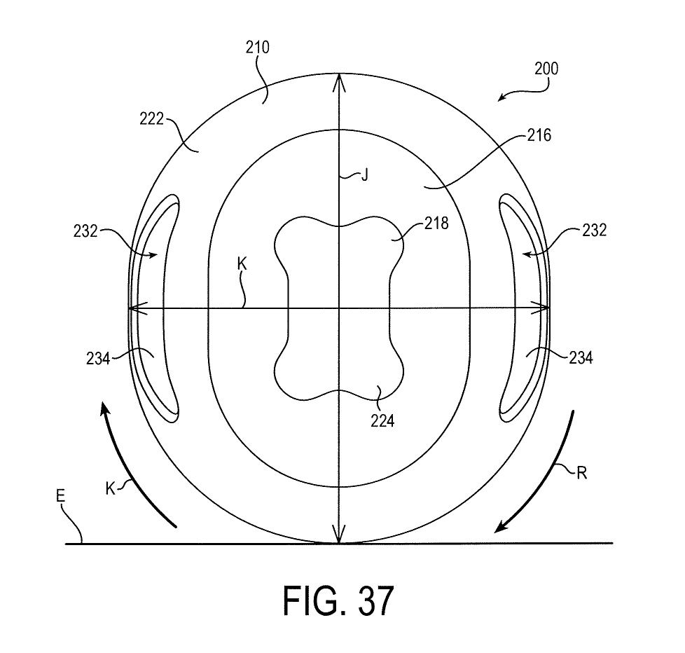

The treat dispenser 200 rolls generally linearly on a generally flat surface due to its generally elliptical exterior surface 222 shown in FIG. 37, which promotes the dispenser 200 to roll R on a generally flat surface around its longitudinal axis Z as shown in FIG. 37. However, the dispenser 200 can roll and bounce irregularly if it begins to partially rotate along any axis, e.g., normal or lateral axis, that is not the longitudinal axis Z.

Referring again to FIG. 37, the dispenser 200 with an elliptical shape can accelerate and decelerate as it rolls. For example, when the major diameter J of the elliptical lobed ends 210 is generally perpendicular to the generally flat surface, the dispenser 200 will accelerate as it rotates about its longitudinal axis Z so that the minor diameter K of the elliptical lobed end 210 is generally perpendicular to the generally flat surface. As the dispenser 200 continues to roll, it will decelerate as the major diameter J of the lobed ends 210 again becomes perpendicular to the generally flat surface. This can enhance the dispenser's 200 unpredictable interaction with the flat surface E, particularly if the dispenser 200 is rolling and/or bouncing while rolling on the flat surface E.

The rolling of the dispenser 200 can stimulate physical engagement by a pet which may chase the dispenser 200 and seek to gain physical control over the dispenser 200 to either chew and/or manipulate the dispenser 200 in an attempt to release treats 400 from the hollow interior cavity 238. If treats 400 are loaded in the dispenser 200, then the treats 400 will randomly contact the inner surface 224 of the hollow interior cavity 238 of the dispenser 200 and freely and randomly bounce within the hollow interior cavity 238 as the dispenser 200 rolls along the generally flat surface E. A treat 400 can randomly exit through the dispensing holes 228 and/or 232 if the treat 400 is in an orientation that permits passage of the treat 400 through the dispensing holes 228 and/or 232 while the dispenser 200 is rolling. A pet could also nudge the dispenser 200 with its nose, leg, and/or paw to roll the dispenser 200 in an attempt to release a treat(s) 400 from the dispenser 200.

In alternative embodiments, the shaft 204 and lobed ends 210 of the dispenser 200 can have a round, oval or other geometric shape, or any combination thereof, that promotes an unpredictable physical interaction as the dispenser 200 rolls on or forcibly contacts a generally flat surface. For example, a non-limiting embodiment of the dispenser 200 can have a shaft 204 with a round cross section, a lobed end 210 with an elliptical cross section and a lobed end with a round cross section, which would cause the dispenser 200 to unpredictably wobble or bounce when the dispenser 200 accelerates and decelerates while rolling on the flat surface. Such a configuration would also further promote a random bounce effect when the dispenser 200 forcibly contacts and rebounds from a generally flat surface E. Other alternative geometrically-shaped lobed ends 210 can enhance unpredictability of the dispenser 210 in spatial movement, in particular with lobed ends having different geometric shapes from one another.

If treat dispenser 200 is resting or rolling on a generally flat surface E, the curved internal surface 224 of the dispenser 200 inherently biases treats 400 within the hollow interior cavity 238 to move toward and/or into the portion of the hollow interior cavity 238 in the lobed ends 210 of the dispenser 200. When the dispenser 200 rolls, and if it is loaded with treats 400, the treats 400 may be released from the elliptical dispensing holes 228, the arcuate dispensing holes 232, the loading hole 218, or other geometrically-shaped dispensing hole provided with the dispenser 200. But, as the treats 400 in the hollow interior cavity 238 are released from the dispenser 200 through dispensing holes 228 and/or 232 as it rolls and decrease in number, the treats 400 will tend to move laterally toward the lobed ends 210 and be released through the arcuate dispensing openings 232 in the lobed ends 210 of the dispenser 200.

The treat dispenser 200 can also be manipulated by a pet that attempts to intercept the dispenser 200 moving unpredictably and control the spatial movement of dispenser 200 with its legs, paws, nose, and/or teeth. Physical interaction between a pet and/or human and a dispenser 200 in motion can further enhance the unpredictability of the dispenser's physical interaction, e.g., bounce, with a surface. When being manipulated, the dispenser 200 visually presents the treats 400, which emit a scent that entices the pet to obtain the treats 400.

Similar to the dispenser 100, 100′ in FIGS. 1-12, 17-23, the structure of the dispenser 200 and its material composition allow the dispenser 200 to be chewed on, while protecting the treats 400 from being crushed as a pet chews on the dispenser 200. This challenges the pet to continue to manipulate the dispenser 200 so that a treat 400 falls out of the dispenser 200 through a dispensing hole 228 or 232. This prolongs a pet's cognitive engagement with the dispenser 200 because the pet needs to physically manipulate the unique structure of the dispenser 200 to cause it to randomly release treats 400. Multiple treats 400 loaded in the dispenser 200 will further prolong a pet's engagement with the dispenser 200 until the pet either tires from playing with the dispenser 200 or causes the release of all treats 400 loaded in the hollow interior cavity 238 of the dispenser 200. For example, the dispenser 200 can have 1-20 or more treats 400 loaded into the hollow interior cavity 238.

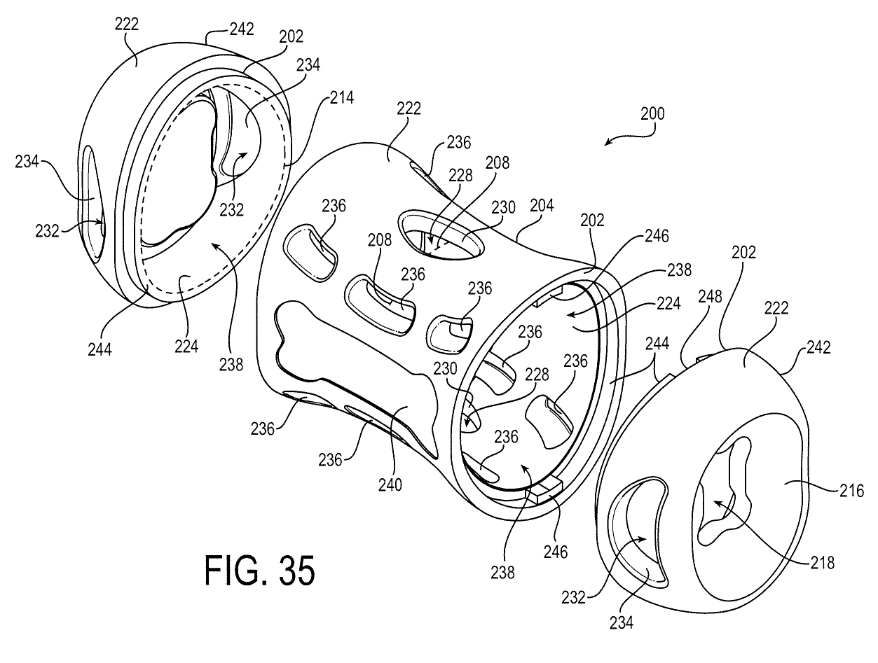

Similar to the dispenser 100, 100′ in FIGS. 1-12, 17-23, the treat dispenser 200 can be manufactured using various molding techniques that include use of core molding and pull-out molding to form a unibody construction, as well as injection molding of subparts that are later adhered, fused or heat sealed together to form the dispenser 200. In an embodiment, the dispenser 200 is molded in subparts that are joined together with a glue or thermoset adhesive, or are fused together using heat welding or chemical fusion. For example, the dispenser 200 can be molded in subparts that are joined together along a joining interface that can have mating curvilinear surfaces, corresponding lap joint surfaces, corresponding projections and recesses, or other interface that promotes joining of the subparts to form the dispenser 200. The subparts can be end portions 242 used to form the lateral aspects of the lobed ends 210, as shown in FIG. 35, that can be joined with or adhered to the shaft 204 using a lap joint 244 with a corresponding alignment notch 246 and recess 248. The corresponding notch 246 and recess 248 may be unique to each end of the shaft 204 so that the end portions 242 are adhered to correct ends of the shaft 204. In an alternative embodiment, two longitudinal ½ segments of the dispenser 200, such as those shown in FIGS. 36a, 36b may be adhered together to form the dispenser 200. In a non-limiting example, the end portions 242 can be solvent bonded to corresponding surfaces on the lobed ends 244 using a short cure adhesive (DongGuan, JT-499A) because the alignment notch 246 and corresponding recess on each end of the shaft 204 provide proper alignment of the subparts.

Pet safety can be considered when selecting a size of treat dispenser 100, 100′, and even dispenser 200, for use in pet engagement. One significant benefit provided by the invention is the non-choking safety feature should dispenser 100, 100′ or dispenser 200 become lodged in a pet's throat. The safety feature is provided by (1) apertures 122 and dispensing openings 124, 126 of treat dispenser 100, 100′, and (2) the dispensing openings 228, 232, gripping holes 236, and loading hole 218 of dispenser 200, which provide sufficient means for air to freely pass through any dispenser of the invention should a dispenser become lodged in a pet's throat.

While the invention is disclosed for use in connection with pets, it may also be adapted for use with or without treats with humans and other non-domesticated animals.

While the invention is described in conjunction with specific embodiments, many alternatives, modifications, permutations and variations will become apparent to those skilled in the art in light of the foregoing description. Accordingly, it is intended that the invention embraces all such alternatives, modifications, permutations and variations as falling within the scope of the claims below.

We claim:

1. A pet treat dispenser comprising:
a structure made from an elastic material, the structure comprising a curved exterior surface and a hollow inner cavity defined by an interior surface of the structure, wherein the structure is configured to retain one or more treats in the hollow inner cavity, and wherein the structure is configured to bounce randomly when a portion of the curved exterior surface forcibly contacts a generally flat surface; and
a dispensing hole in communication with the hollow inner cavity, wherein the dispensing hole is configured to randomly release the treats from the hollow inner cavity when the dispenser rotates or bounces, and wherein an open area of the dispensing hole is about 140 to 500% of an area of a surface of the treat.

2. A hollow treat dispensing device comprising:
a series of substantially piriform-shaped, alternating loops, wherein each loop comprises a rounded portion opposite an interconnected portion and provides communication into the hollow treat dispensing device;
an intra-loop member comprising a segment extending from the interconnected portion toward the rounded portion of a loop and a pair of arms extending perpendicularly from the segment to a lateral surface of the loop, wherein the intra-loop member is provided in at least one of the alternating loops; and
an end cap positioned adjacent to rounded portions of the loops at opposing ends of the device;
wherein inner surfaces of the substantially piriform-shaped, alternating loops, of the segment and the pair of arms of the intra-loop member, and of the end caps are curved substantially along a same radius of curvature.

3. The device of claim 2 wherein each loop forms a portion of an adjacent loop in the series.

4. The device of claim 2 wherein the pair of arms curve away from the rounded portion of each loop.

5. The device of claim 2 wherein the pair of arms curve toward the rounded portion of each loop.

6. The device of claim 2 wherein the segment extends from the interconnected portion to the pair of arms.

7. The device of claim 6 wherein the pair of arms and the lateral surface of the rounded portion of the loop define a dispensing opening configured to permit a treat to randomly fall out of the hollow treat dispensing device.

8. The device of claim 2 wherein the segment extends from the interconnected portion to the rounded portion, thereby crossing the pair of arms.

9. The device of claim 8 wherein a lateral surface of a portion of the segment and a lateral surface of the rounded portion of the loop defines two dispensing openings configured to permit a treat to randomly fall out of the hollow treat dispensing device when the device rotates or bounces.

10. The device of claim 2 wherein the device is formed from an elastic material comprising a thermoplastic polymer, an elastomeric polymer, a thermoset polymer, or any combination thereof.

11. The device of claim 2 wherein the device is configured to bounce randomly upon forcible contact with a generally flat surface.

12. The device of claim 2 wherein the device is configured to roll substantially linearly along a generally flat surface.

13. The device of claim 2 wherein each of the loops, the segments, and the pair of arms have a cross section comprising a semicircular external surface opposite the inner peripheral surface.

14. A spherical framework defining a hollow interior cavity comprising:
a curved, continuous segment comprising lateral surfaces that define a plurality of alternating, substantially piriform-shaped openings, wherein each opening is intersected by a cross member that extends between and joins with one of the lateral surfaces of the curved, continuous segment that defining a piriform-shaped opening; and
two caps that join opposing ends of the spherical framework;
wherein the continuous curved segment, the cross member, and the two caps provide inner surfaces having a substantially similar internal radius of curvature; and
wherein the spherical framework is configured to bounce erratically when striking a substantially flat surface.

15. The framework of claim 14 wherein the curved, continuous segment conjoins to form each substantially piriform-shaped opening.

16. The framework of claim 14 wherein an external peripheral surface of the curved, continuous segment is curved along a first external radius of curvature.

17. The framework of claim 16 wherein the cross member comprises a first curved segment that is perpendicular to a second curved segment.

18. The framework of claim 17 wherein the first curved segment and the second curved segment have an external surface that is curved along the first external radius of curvature.

19. The framework of claim 17 wherein the first curved segment or the second curved segment has an external surface along a second external radius of curvature that is smaller than the first external radius of curvature.

20. The framework of claim 17 wherein at least one piriform-shaped opening comprises two dispensing openings defined by the cross member and a portion of the lateral surface of the curved, continuous segment.

21. The framework of claim 16 wherein the cross member comprises a first curved segment and a second curved segment that extends from the lateral surface of the curved, continuous segment and is joined with the first curved segment.

22. The framework of claim 21 wherein the first curved segment and the second curved segment have an external surface curved along the first external radius of curvature.

23. The framework of claim 21 wherein at least one piriform-shaped opening comprises a dispensing opening defined by the first curved segment and a portion of the lateral surface of the curved, continuous segment.

24. The framework of claim 14 wherein the curved, continuous segment and the cross member have a cross section comprising a semicircular surface opposite the inner surfaces.

25. The framework of claim 14 wherein the framework is formed from an elastic material comprising a thermoplastic polymer, an elastomeric polymer, or a thermoset polymer, or any combination thereof.

26. A pet treat dispensing device comprising:
a substantially spherical framework molded from an elastic material, wherein the spherical framework has a peripheral surface and a hollow interior cavity, the peripheral surface includes two end caps, a continuous segment that is curved into alternating piriform shaped loops with a cross member intersecting each loop;
a plurality of apertures defined by each piriform shaped loop and cross member; and
at least one pet treat within the hollow interior cavity,
wherein at least one of the apertures is a dispensing opening configured to permit random passage of the pet treat as the device rolls or bounces.

27. The pet treat dispensing device of claim 26 wherein the elastic material comprises a thermoplastic polymer, an elastomeric polymer, or a thermoset polymer, or any combination thereof.

28. The pet treat dispensing device of claim 26 wherein the device is configured to bounce randomly when a portion of the continuous segment or a portion of a cross member forcibly contacts a generally flat surface.

29. The pet treat dispensing device of claim 26 wherein the device is configured to roll substantially linearly along a generally flat surface.

30. A method of interacting with a pet, the method comprising the steps of:
providing a treat dispensing device including a spherical framework with a hollow interior and further comprising:
a curved, continuous segment having lateral surfaces that define a plurality of alternating, substantially piriform-shaped openings, wherein each opening is intersected by a cross member that extends between and joins with one of the lateral surfaces of the curved, continuous segment, and
at least one dispensing opening defined by a cross member and one of the lateral surfaces of the substantially piriform-shaped openings, wherein the treat dispensing device is configured to retain one or more pet treats within the framework and also to randomly release one or more pet treats through the dispensing opening when the pet treat is oriented relative to the dispensing opening in a manner that permits passage of the pet treat through the dispensing opening;
inserting at least one pet treat through the dispensing opening into the hollow interior, wherein the at least one pet treat is retained within the framework; and
providing the treat dispensing device to the pet so that the pet can manipulate the treat dispensing device to dispense at least one of the pet treats.

31. A pet treat dispensing device comprising:
a body in the form of a shaft with lobed ends, the body having an external surface and an internal surface that defines a hollow interior cavity configured to contain at least one pet treat, wherein the shaft has a first internal perimeter centrally located along the shaft, the first internal perimeter is smaller than a second internal perimeter of each of the lobed ends; and
one or more treat dispensing holes providing communication through the body into the hollow interior cavity, wherein the treat dispensing hole is configured to retain the pet treat in the hollow interior cavity until the pet treat is oriented relative to the dispensing hole in a manner that permits passage of the pet treat through the dispensing hole as the device rotates or bounces;
wherein at least one of the lobed ends has an external side surface that is closed.

32. The device of claim 31 wherein the first internal perimeter of the shaft and the second internal perimeter of the lobed ends defines at least one of a circle, an ellipsis, or an oval.

33. The device of claim 31 comprising two dispensing holes through the shaft of the body.

34. The device of claim 33 wherein the two dispensing holes are in the shape of at least one of a circle, an ellipsis, or an oval, or any combination thereof.

35. The device of claim 31 comprising at least two dispensing holes provided through the lobed ends of the body.

36. The device of claim 35 comprising four dispensing holes provided through the lobed ends of the body.

37. The device of claim 36 wherein the dispensing holes are in the shape of at least one of a circle, an ellipsis, an oval, an arcuate, a semi-ellipsis, or a semicircle, or any combination thereof.

38. The device of claim 31 wherein the external side surface of each lobed end is flat, concave, or convex.

39. The device of claim 31 wherein the external side surface of each lobed end is closed.

40. The device of claim 39 comprising a loading hole in the external side surface of one of the lobed ends wherein the loading hole communicates with the hollow interior cavity.

41. The device of claim 40 wherein the loading hole is a slot, a circle, an ellipsis, an oval, or a bone shape that permits passage of a pet treat into the hollow interior cavity.

42. The device of claim 31 comprising at least two gripping indentations provided in opposing external surfaces of the shaft, wherein the gripping indentations do not permit passage of pet treats.

43. The device of claim 31 wherein the internal surface of the body is arced away from the shaft to the lobed ends.

44. The device of claim 31 wherein the body is made from an elastic material comprising a thermoplastic polymer, an elastomeric polymer, a thermoset polymer, or any combination thereof.

45. The device of claim 31 wherein the device is configured to roll along a central longitudinal axis when portions of the external surfaces of the lobed ends contact a generally flat surface.

46. The device of claim 45 wherein the device is configured to accelerate and decelerate as it rolls about the central longitudinal axis.

47. A pet treat dispensing device comprising:
a wall in the form of a shaft having lobed ends with sides, the wall having an external surface and an internal surface that defines a hollow interior cavity configured to contain at least one pet treat, wherein the internal surface arcs away from a first internal perimeter of a central aspect of the shaft to the lobed ends, wherein the lobed ends each have a second internal perimeter that is greater than the first internal perimeter of the shaft;
at least one dispensing hole that provides communication through the wall into the hollow interior cavity of the device, wherein the at least one dispensing hole is configured to retain at least one pet treat in the hollow interior cavity until the pet treat is oriented in a manner that permits passage of the pet treat through the dispensing hole; and
a loading hole provided through the side of one of the lobed ends into the hollow interior cavity, wherein the loading hole is configured to permit passage of a pet treat into the hollow interior cavity and to sufficiently retain the pet treat in the hollow interior cavity as the device rotates or bounces.

48. The device of claim 47 wherein the first internal perimeter of the shaft and the second internal perimeters of the lobed ends define at least one of a circle, an ellipsis, or an oval.

49. The device of claim 47 comprising two dispensing holes through the shaft.

50. The device of claim 49 wherein the two dispensing holes are in the shape of a circle, an ellipsis, or an oval, or any combination thereof.

51. The device of claim 47 comprising at least two dispensing holes provided through the lobed ends of the body.

52. The device of claim 51 comprising four dispensing holes provided through the lobed ends of the body.

53. The device of claim 51 wherein the dispensing holes are in the shape of at least one of a circle, an ellipsis, an oval, an arcuate, a semi-ellipsis, a semicircle, or any combination thereof.

54. The device of claim 47 wherein the sides of the lobed ends are flat, concave, or convex.

55. The device of claim 54 wherein at least one of the sides of the lobed ends is closed.

56. The device of claim 47 wherein the loading hole is a slot, a circle, an ellipsis, an oval, or a bone shape that permits passage of a pet treat into the hollow interior cavity.

57. The device of claim 47 comprising at least two gripping indentations provided in opposing external surfaces of the shaft, wherein the gripping indentations have a size that does not permit passage of pet treats.

58. The device of claim 47 wherein the wall is made from an elastic material comprising a thermoplastic polymer, an elastomeric polymer, a thermoset polymer, or any combination thereof.

59. The device of claim 47 wherein the device is configured to roll along a longitudinal axis when portions of the external surfaces of the lobed ends contact with a generally flat surface.

60. The device of claim 59 wherein the device is configured to accelerate and decelerate as it rolls.

61. A method of interacting with a pet animal, the method comprising the steps of:
providing a treat dispensing device comprising:
a wall in the form of a shaft having lobed ends, the wall having an external surface and an internal surface defining a hollow interior cavity that is configured to retain at least one pet treat, wherein the internal surface arcs away from a first internal perimeter of a central portion of the shaft to second internal perimeters of the lobed ends, wherein the second internal perimeter has a diameter that is greater than the first internal perimeter; and
at least one dispensing hole that provides communication through the wall into the hollow interior cavity of the device, wherein the at least one dispensing hole is configured to retain at least one pet treat in the hollow interior cavity until the pet treat is oriented in a manner that permits passage of the pet treat through the dispensing hole;
placing at least one pet treat into the hollow interior cavity, wherein the at least one pet treat is contained within the hollow interior cavity; and
providing the treat dispensing device to a pet animal so that the pet animal can manipulate the treat dispensing device to dispense at least one of the pet treats through the at least one dispensing hole.
